(19) United States
(12) Patent Application Publication
(10) Pub. No.: US 2022/0332578 A1
(43) Pub. Date: Oct. 20, 2022

(54) PLASMA-ASSISTED SYNTHESIS FOR SOLID-STATE ELECTROLYTE MATERIALS

(71) Applicant: Solid Power Operating, Inc., Louisville, CO (US)

(72) Inventors: Clint R. BICKMORE, Louisville, CO (US); Brian E. FRANCISCO, Arvada, CO (US)

(21) Appl. No.: 17/722,242

(22) Filed: Apr. 15, 2022

Related U.S. Application Data
(60) Provisional application No. 63/175,187, filed on Apr. 15, 2021.

(51) Int. Cl. C01B 17/22; H01M 10/0562

(52) U.S. Cl. CPC C01B 17/22; H01M 10/0562; H01M 2300/0068

(57) ABSTRACT

A method for synthesizing solid-state electrolytes and for synthesizing precursors for solid-state electrolytes by plasma-processing.

### CROSS-REFERENCE TO RELATED APPLICATION

This application is related to and claims priority under 35 U.S.C. § 119 from U.S. Provisional Application No. 63/175,187 filed Apr. 15, 2021 entitled “Plasma-Assisted Synthesis for Solid-State Electrolyte Material,” the entire contents of which is fully incorporated by reference herein for all purposes.

This application is related to U.S. Provisional Application No. 63/331,701 filed Apr. 15, 2022 entitled “Plasma System for Producing Solid-State Electrolyte Material,” the entire contents of which is fully incorporated by reference herein for all purposes

### TECHNICAL FIELD

Various embodiments described herein relate to the field of solid-state primary and secondary electrochemical cells, electrodes and electrode materials, electrolyte and electrolyte compositions of matter, and corresponding methods of making and using same.

### BACKGROUND

The ever-increasing number and diversity of mobile devices, the evolution of hybrid/electric automobiles, and the development of Internet-of-Things devices, among other things, is driving ever greater need for battery technologies with improved reliability, capacity, thermal characteristics, lifetime and recharge performance. Currently, although lithium solid-state battery technologies offer potential increases in safety, packaging efficiency, and enable new high-energy chemistries as compared to other types of batteries, improvements in lithium battery technologies and other solid-state technologies are needed, especially improvements in lower cost production.

It is with these observations in mind, among others, that aspects of the present disclosure were conceived.

### SUMMARY

Provided herein is a method of synthesizing a solid-state electrolyte. The method comprises: (a) providing at least one precursor; (b) preparing the at least one precursor for plasma-processing by milling, grinding, mixing, alloying, and/or high shear mixing; and (c) plasma-processing the at least one precursor to form the solid-state electrolyte, wherein the plasma-processing includes at least providing a plasma gas and an excitation source to produce a plasma and providing a carrier gas to carry the at least one precursor through the plasma.

In some embodiments, the at least one precursor comprises one or more of at least one lithium-containing material, at least one phosphorus-containing material, at least one sulfur-containing material, and at least one halogen-containing material. In some embodiments, the solid-state electrolyte material comprises a crystalline material, a glass material, or a glass-ceramic material.

In some embodiments, the lithium-containing material comprises Li₂S, Li₂O, Li₂CO₃, Li₂SO₄, LiNO₃, Li₃N, Li₂NH, LiNH₂, LiF, LiCl, LiBr, LiI, or LiX₍₁₋ₐ₎Yₐ, wherein the X and Y include halogens, such as F, Cl, Br, or I, and/or pseudohalogens, such as BH₄, BF₄, OCN, CN, SCN, SH, NO, or NO₂ where 0≤a≤1.

In some embodiments, the phosphorous-containing material comprises a phosphorous sulfide material, a phosphorus nitrogen material, or a phosphorus oxygen material. In some additional embodiments, the phosphorous-containing material comprises a phosphorous sulfide material comprising a formula P₄Sₓ where 3≤x≤10. In still further embodiments, the phosphorous-containing material comprises elemental phosphorus, P₄S₄, P₄S₅, P₄S₆, P₄S₇, P₄S₈, P₄S₉, or P₄S₁₀ (P₂S₅), P₃N₅, or P₂O₅.

In some embodiments, the sulfur-containing material comprises an alkali sulfide, an alkaline earth sulfide, a transition metal sulfide, a post-transition metal sulfide, a metalloid sulfide, or elemental sulfur. In some additional embodiments, the sulfur-containing material comprises H₂S, Li₂S, Na₂S, K₂S, BeS, MgS, CaS, SrS, BaS, TiS₂, ZrS₂, WS₂, FeS₂, NiS₂, CuS₂, AgS, ZnS, Al₂S₃, Ga₂S₃, SnS₂, Sn₂S₃, B₂S₃, SiS₂, GeS₂, Sb₂S₃, Sb₂S₅, or elemental sulfur.

In some embodiments, the halogen-containing material comprises a lithium halide, a sodium halide, a boron halide, an aluminum halide, a silicon halide, a phosphorus halide, a sulfur halide, a germanium halide, an arsenic halide, a selenium halide, a tin halide, an antimony halide, a tellurium halide, a lead halide, an yttrium halide, a magnesium halide, a bismuth halide, a zirconium halide, a lanthanum halide, a transition metal halide, or a lanthanide halide. In some additional embodiments, the halogen-containing material comprises LiF, LiCl, LiBr, LiI, NaF, NaCl, NaBr, NaI, BCl₃, BBr₃, BI₃, AlF₃, AlBr₃, AlI₃, AlCl₃, SiF₄, SiCl₄, SiCl₃, Si₂Cl₅, SiBr₄, SiBrCl₃, SiBr₂Cl₂, SiI₄, PF₃, PF₅, PCl₃, PCl₅, POCl₃, PBr₃, POBr₃, PI₃, P₂Cl₄, P₂I₄, SF₂, SF₄, SF₆, S₂F₁₀, SCl₂, S₂Cl₂, S₂Br₂, GeF₄, GeCl₄, GeBr₄, GeI₄, GeF₂, GeCl₂, GeBr₂, GeI₂, AsF₃, AsCl₃, AsBr₃, AsI₃, AsF₅, SeF₄, SeFe₆, SeCl₂, SeCl₄, Se₂Br₂, SeBr₄, SnF₄, SnCl₄, SnBr₄, SnI₄, SnF₂, SnCl₂, SnBr₂, SnI₂, SbF₃, SbCl₃, SbBr₃, SbI₃, SbF₅, SbCl₅, TeF₄, Te₂F₁₀, TeF₆, TeCl₂, TeCl₄, TeBr₂, TeBr₄, TeI₄, PbF₄, PbCl₄, PbF₂, PbCl₂, PbBr₂, PbI₂, YF₃, YCl₃, YBr₃, YI₃, MgF₂, MgCl₂, MgBr₂, Mg₂, BiF₃, BiCl₃, BiBr₃, BiI₃, ZrF₄, ZrCl₄, ZrBr₄, ZrI₄, LaF₃, LaCl₃, LaBr₃, or LaI₃.

In some particular embodiments, the at least one precursor is selected from Li₂S, P₂S₅, and LiX, wherein X is one or more halide or pseudo-halide.

In some embodiments, the at least one precursor is reduced in size in step (b) to a particle size from about 1 nm to about 10 mm.

In some embodiments, the excitation source comprises an AC discharge, a DC discharge, a laser discharge, a radiofrequency source, or a microwave source.

In some embodiments, the carrier gas has a pressure from about 1×10⁻⁹ Torr to about 7600 Torr.

In some embodiments, the method further comprises heating the at least one precursor to a crystallization temperature for a period from about 1 microsecond to about 60 seconds.

In some embodiments, the carrier gas comprises a reactive carrier gas or a non-reactive carrier gas.

In an exemplary embodiment, the carrier gas is one of H₂S and sulfur and the at least one precursor is one of Li₂CO₃, Li₂SO₄, and LiOH, which is converted to Li₂S by the plasma-processing. In another exemplary embodiment, the carrier gas is one or more of HCl, HBr, and HI, and the at least one precursor is one of Li₂CO₃, Li₂SO₄, and LiOH, which is converted to one or more of a LiCl, LiBr, or LiI by the plasma-processing.

In some embodiments, the method further comprises a second plasma processing comprising a non-reactive carrier gas.

In some embodiments, the method comprises heating the at least one precursor to an effective heating temperature greater than about 70° C. In some aspects, the method comprises heating the at least one precursor to an effective heating temperature of about 70° C. to about 5000° C.

In some embodiments, the solid-state electrolyte has a substantially round shape. In an exemplary embodiment the solid-state electrolyte appears substantially similar to the solid-state electrolyte in FIG. 2B.

In some embodiments, step (b) is performed in a solvent-free environment. In some embodiments, the solid-state electrolyte material is solvent-free.

In some exemplary embodiments, the solid-state electrolyte has an XRD pattern as shown in FIG. 7. In some exemplary embodiments, the solid-state electrolyte has an XRD pattern as shown in FIG. 11. In some exemplary embodiments, the solid-state electrolyte has an XRD pattern as shown in FIG. 12A. In some exemplary embodiments, the solid-state electrolyte has an XRD pattern as shown in FIG. 12B. In some exemplary embodiments, the solid-state electrolyte has an XRD pattern as shown in FIG. 13. In some exemplary embodiments, the solid-state electrolyte has an XRD pattern as shown in FIG. 14.

In some exemplary embodiments, the solid-state electrolyte has an EDS spectrum as shown in FIG. 9B. In some exemplary embodiments, the solid-state electrolyte has an EDS spectrum as shown in FIG. 10C. In some exemplary embodiments, the solid-state electrolyte has an EDS spectrum as shown in FIG. 10F.

In some embodiments, the plasma-processing further comprises forming a eutectic material.

In some embodiments, the method further comprises milling or grinding the solid-state electrolyte.

Further provided herein is a solid-state electrolyte produced by the method of the present disclosure. Thus, provided is a solid-state electrolyte produced by the method comprising: (a) providing at least one precursor; (b) preparing the at least one precursor for plasma-processing by milling, grinding, mixing, alloying, and/or high shear mixing; and (c) plasma-processing the at least one precursor to form the solid-state electrolyte, wherein the plasma-processing includes at least providing a plasma gas and an excitation source to produce a plasma and providing a carrier gas to carry the at least one precursor through the plasma.

Further provided herein is an electrochemical cell comprising the solid-state electrolyte made by the process of the present disclosure. Thus, provided is an electrochemical cell comprising a solid-state electrolyte produced by the method comprising: (a) providing at least one precursor; (b) preparing the at least one precursor for plasma-processing by milling, grinding, mixing, alloying, and/or high shear mixing; and (c) plasma-processing the at least one precursor to form the solid-state electrolyte, wherein the plasma-processing includes at least providing a plasma gas and an excitation source to produce a plasma and providing a carrier gas to carry the at least one precursor through the plasma.

Further provided herein is a method of synthesizing a solid-state electrolyte precursor comprising: (a) providing at least one reactant; (b) preparing the at least one reactant for plasma-processing by milling, grinding, mixing, alloying, and/or high shear mixing; and (c) plasma-processing the at least one reactant to form the solid-state electrolyte precursor, wherein the plasma-processing comprises providing a plasma gas and an excitation source to produce a plasma and providing a carrier gas to carry the at least one reactant through the plasma.

In some embodiments, the at least one reactant is one or more of at least one lithium-containing reactant, at least one phosphorus-containing reactant, at least one sulfur-containing reactant.

In some embodiments, the at least one lithium-containing reactant comprises Li₂SO₄, LiOH, LiX, or LiY, where X and Y are halogens, such as F, Cl, Br, or I, and/or pseudohalogens, such as BH₄, BF₄, OCN, CN, SCN, SH, NO, or NO₂.

In some embodiments, the at least one phosphorus-containing reactant comprises P₂S₅ or elemental phosphorus.

In some embodiments, the at least one sulfur-containing reactant comprises H₂S or elemental sulfur.

In some embodiments, the at least one reactant comprises carbon, elemental boron, or ammonia.

In some embodiments, the at least one precursor is reduced in size in step (b) to a particle size from about 1 nm to about 10 mm.

In some embodiments, the excitation source comprises an AC discharge, a DC discharge, a laser discharge, a radiofrequency source, or a microwave source.

In some embodiments, the carrier gas has a pressure from about 1×10⁻⁹ Torr to about 7600 Torr.

In some embodiments, the carrier gas comprises a reactive carrier gas or a non-reactive carrier gas.

In some embodiments, step (b) is performed in a solvent-free environment. In some additional embodiments, the solid-state electrolyte precursor is solvent-free.

In some exemplary embodiments, the solid-state electrolyte precursor has an XRD pattern as shown in FIG. 13. In some exemplary embodiments, the solid-state electrolyte precursor has an XRD pattern as shown in FIG. 14.

In some embodiments, the method may further comprise milling or grinding the solid-state electrolyte precursor.

Further provided herein is a method of synthesizing a solid-state electrolyte, the method comprising (a) providing at least one reactant; (b) preparing the at least one reactant for plasma-processing by milling, grinding, mixing, alloying, and/or high shear mixing; (c) plasma-processing the at least one reactant to form at least one precursor, wherein the plasma-processing comprises providing a plasma gas and an excitation source to produce a plasma and providing a carrier gas to carry the at least one reactant through the plasma; (d) preparing the at least one precursor for plasma-processing by milling, grinding, mixing, alloying, and/or high shear mixing; and (e) plasma-processing the at least one precursor to form the solid-state electrolyte material, wherein the plasma-processing includes at least providing a plasma gas and an excitation source to produce a plasma and providing a carrier gas to carry the at least one precursor through the plasma.

Further provided herein is a method of synthesizing Li₂S comprising: (a) providing at least one reactant; (b) preparing the at least one reactant for plasma-processing by milling, grinding, mixing, alloying, and/or high shear mixing; and (c) plasma-processing the at least one reactant to form the Li₂S, wherein the plasma-processing includes at least providing a plasma gas and an excitation source to produce a plasma and providing a carrier gas to carry the at least one reactant through the plasma. In some embodiments, the at least one reactant comprises Li₂CO₃ and elemental sulfur.

Further provided herein is a method of synthesizing a solid-state electrolyte comprising: (a) providing at least one precursor; (b) preparing the at least one precursor for plasma-processing by milling, grinding, mixing, alloying, and/or high shear mixing; (c) plasma-processing the at least one precursor to melting prior to forming the solid-state electrolyte, wherein the plasma-processing includes at least providing a plasma gas and an excitation source to produce a plasma and providing a carrier gas to carry the at least one precursor through the plasma; and (d) quenching the solid-state electrolyte and/or the at least one precursor.

Further provided herein is a method of synthesizing a solid-state electrolyte. The method comprises: (a) providing at least one precursor; and (b) plasma-processing the at least one precursor to form the solid-state electrolyte, wherein the plasma-processing includes at least providing a plasma gas and an excitation source to produce a plasma and providing a carrier gas to carry the at least one precursor through the plasma.

### BRIEF DESCRIPTION OF DRAWINGS

The various objects, features, and advantages of the present disclosure set forth herein will be apparent from the following description of embodiments of those inventive concepts, as illustrated in the accompanying drawings. It should be noted that the drawings are not necessarily to scale, may only include certain features representative of various features of an embodiment, the emphasis being placed on illustrating the principles and other aspects of the inventive concepts. In any methods discussed herein, only some operations may be performed, some operations may be done separately from others, and additional operations are possible, with any method possibly only including representative features of the embodiment. Also, in the drawings, any like reference characters may refer to the same parts or similar throughout the different views. It is intended that the embodiments and figures disclosed herein are to be considered illustrative rather than limiting.

FIG. 1 is a flow chart of a process for plasma-assisted synthesis of a solid-state electrolyte material, in accordance with an embodiment of the present disclosure.

FIGS. 2A-2B show scanning electron micrographs of plasma-processed materials according to the present disclosure. FIG. 2A shows the various morphologies possible after plasma-processing. FIG. 2B is a zoomed-in version of FIG. 2A.

FIG. 3 is a flow chart of a process for plasma-assisted synthesis of a solid-state electrolyte precursor, in accordance with an embodiment of the present disclosure.

FIG. 4 is a flow chart of an exemplary powder thermal spray plasma processing apparatus of the present disclosure.

FIG. 5 is a diagram of an exemplary powder thermal spray plasma processing apparatus of the present disclosure.

FIG. 6 is a diagram of an exemplary pellet plasma processing apparatus of the present disclosure.

FIG. 7 is an X-Ray Diffraction (XRD) spectrum of a Li₃OCl₁₋ₓBrₓ solid-state electrolyte synthesized by a fast reaction powder thermal spray process.

FIGS. 8A-C show scanning electron micrographs of solid-state electrolyte materials synthesized by a fast reaction powder thermal spray process. FIG. 8A shows a particle comprising Li₃OCl₁₋ₓBrₓ, wherein the particle comprises spherical morphology. FIG. 8B is a zoomed-in view of the particle of FIG. 8A. FIG. 8C shows another particle comprising Li₃OCl₁₋ₓBrₓ.

FIG. 9A shows a scanning electron micrograph of a particle comprising Li₃OCl₁₋ₓBrₓ having a glassy morphology. FIG. 9B shows the energy-dispersive X-ray spectroscopy (EDS) spectrum of the selected area of the particle of FIG. 9A.

FIG. 10A shows a scanning electron micrograph of a particle comprising Li₃OCl₁₋ₓBrₓ having a jagged morphology. FIG. 10B shows the same particle with a selected area overlaid thereon. FIG. 10C shows the EDS spectra for the selected area shown in FIG. 10B. FIG. 10D shows the atom composition of the particle as determined by EDS. FIG. 10E shows the atom composition of the particle shown in FIG. 10A. FIG. 10F shows the EDS spectra for the particle of FIG. 10A. FIGS. 10G-H show the areas of the particle containing bromine and chlorine, respectively.

FIG. 11 shows an XRD pattern of a Li₃OCl solid-state electrolyte material synthesized by a fast reaction powder thermal spray process.

FIG. 12A shows XRD patterns of a Li₅B₇S₁₃ solid-state electrolyte material and a L₁₀B₁₀S₂₀ solid-state electrolyte material synthesized by a pellet plasma and annealing process. FIG. 12B shows XRD patterns of the Li₅B₇S₁₃ solid-state electrolyte material and the Li₁₀B₁₀S₂₀ solid-state electrolyte material synthesized by a pellet plasma and annealing process and by an ampule melt process.

FIG. 13 shows an XRD pattern of a Li₆PS₅Cl solid state electrolyte material synthesized by a fast reaction powder thermal spray process.

FIG. 14 shows an XRD pattern of Li₂S synthesized by a pellet plasma process.

FIGS. 15A-15K show various scanning electron micrographs of solid state electrolyte particles synthesized by a fast reaction powder thermal spray process.

FIGS. 16A-16B show scanning electron micrographs of Li₆PS₅Cl synthesized by a fast reaction powder thermal spray process.

FIG. 17A shows a scanning electron micrograph of Li₆PS₅Cl synthesized by a fast reaction powder thermal spray process with selected areas overlaid thereon. FIGS. 17B-17D show EDS spectra for selected areas 1-3, respectively.

FIG. 18A shows a scanning electron micrograph of Li₆PS₅Cl synthesized by a fast reaction powder thermal spray process with selected areas overlaid thereon. FIGS. 18B and 18C show EDS spectra for selected areas 1 and 2, respectively.

FIG. 19A shows a scanning electron micrograph of Li₆PS₅Cl synthesized by a fast reaction powder thermal spray process with a selected area overlaid thereon. FIG. 19B shows an EDS spectrum for the selected area.

FIG. 20A shows a scanning electron micrograph of Li₆PS₅Cl synthesized by a fast reaction powder thermal spray process with a selected area overlaid thereon. FIG. 20B shows an EDS spectrum for the selected area.

### DETAILED DESCRIPTION

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well-known methods, processes, devices, and systems finding application in the various embodiments described herein are not disclosed in detail.

Before the present invention is disclosed and described, it is to be understood that this invention is not limited to the particular methods, compositions of matter, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL”.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open-ended term, like “comprising” or “including,” it is understood that direct support should be afforded also to “consisting essentially of” language as well as “consisting of” language as if stated explicitly and vice versa.

Provided herein are methods of synthesizing solid-state electrolyte materials and precursors for solid-state electrolyte materials. The synthesis is accomplished by first providing reactants or precursors, preparing the precursors for plasma-processing by reducing the particle size of the reactants or precursors, and plasma-processing the prepared reactants or precursor. As used herein “precursor” refers to specific reactants or materials that are used to make solid-state electrolytes. In this sense, all precursors may be considered reactants, but not all reactants may be considered precursors.

The plasma-processing generally includes providing a plasma gas and an excitation source. The excitation source generates a plasma by applying an electric current through the plasma gas. The reactants or precursors are carried through the generated plasma by a carrier gas and are rapidly heated, causing different chemical and physical interactions and changes in morphology to occur depending on the species of the reactants or precursors. The carrier gas may be the same as or different from the plasma gas. As used herein, the phrase “through the plasma” can mean that a particle travels makes contact with the plasma, or it can mean that the particle travels adjacent to the plasma. In some exemplary embodiments, the plasma may be in the shape of an extended toroid, wherein the precursors or reactants travel through the center of the toroid and do not make direct contact with the plasma. It should be understood that the plasma can take many shapes and forms and is not limited to that of a toroid or an extended toroid.

The plasma forms a hot zone that heats the material passing through it. As used herein, the “hot zone” is defined as an area adjacent to the plasma having a temperature that is 75%±25% of the temperature of the plasma (e.g., within about 50% of the approximate temperature of the plasma). The area of the hot zone may be adjusted by changing the plasma gas, the flow rate of the plasma gas, the temperature of the plasma, the current, or other factors. The residence time of the reactants or precursors in the hot zone is related to ensuring the desired chemical and/or physical changes take place, and the implemented residence time may depend on material properties including thermal conductivity, heat capacity, particle size, etc.

In some embodiments, the plasma-processing may comprise heat-treating the reactants or precursors. When the reactants or precursors pass through the plasma hot zone, the reactants or precursors may melt, crystallize, sinter, anneal, or volatilize. The melting, crystallizing, sintering, annealing, or volatilizing may occur when the reactants or precursors are rapidly taken to from an original ambient temperature to an effective heating temperature in a fast reaction period of time, and then rapidly cooled/quenched to a solid state from the effective heating temperature back to the original ambient temperature (e.g., about 70° C.) in a fast reaction period of time. The ranges discussed above for an effective heating temperature and the reverse (i.e., subsequent temperature range drop) for cooling to solid state are incorporated herein by reference. The melting, crystallizing, sintering, annealing, or volatilizing, and the subsequent cooling/quenching may all substantially occur during the period of time spanning from when the reactants or precursors are about to enter the hot zone to after they have left the hot zone to a point sufficiently to cool, quench, and/or return to solid state. This type of plasma-processing may be particularly useful when forming solid-state electrolytes. More specifically, in some aspects, the plasma may define an annealing zone. The annealing zone is defined as an area preceding the plasma wherein the temperature is high enough to anneal the solid-state electrolyte materials or precursors, but low enough such that the solid-state electrolyte materials or precursors are not substantially melted or vaporized. The size of the annealing zone may be adjusted by changing the temperature of the plasma, the length of the plasma, the carrier gas flow rate, or other factors.

In some embodiments, the plasma-processing may comprise quenching the solid-state electrolyte and/or the precursor after it has traveled through the plasma. The quenching may occur with or without a cooling system, such as a water jacket surrounding the plasma chamber. The quenching process may yield a glassy-phase, crystalline, and/or amorphous solid-state electrolyte and/or precursor. The solid-state electrolyte and/or precursor may have a temperature of less than 100° C. after quenching, such as less than 90° C., less than 80° C., less than 70° C., less than 60° C., less than 50° C., less than 40° C., or less than 30° C. In some aspects, the solid-state electrolyte and/or precursor may have a temperature equal to the original ambient temperature after the quenching.

In some embodiments, the plasma-processing may comprise transformation of the reactants or precursors. The transformation generally occurs via a chemical reaction that takes place when the reactants or precursors interact with each other when flowing through the hot zone. In some aspects, the plasma-processing may form a desired product as well as one or more byproducts. The byproducts may be separated after the plasma-processing by methods known in the art. In some aspects, the byproducts may include gaseous byproducts that may be vented from the plasma chamber to the atmosphere, to a ventilation hood, or to a scrubber.

In some embodiments, the plasma-processing may comprise vaporization of at least one of the reactants or precursors. In some aspects, the vaporization of at least one of the reactants or precursors may include complete ionization or atomization of the reactants or precursors. The vaporization occurs in hot zone of the plasma and may be followed by condensation of the resultant precursors or the solid-state electrolytes after the vaporized material has cooled. In some aspects, the plasma-processing results in vaporization of the precursors and/or reactants in the hot zone. This rapid heating and short transit time results in rapid cooling whereby the precipitation is a homogeneous condensation of the precursors and/or the reactants.

In one embodiment, the present invention provides a method for producing an amorphous composition or a combination of amorphous compositions. The amorphous composition may comprise at least one amorphous solid-state electrolyte. The amorphous composition may also comprise at least one amorphous reactant or precursor. The amorphous composition comprising at least one amorphous solid-state electrolyte may comprise glassy, glassy phase, or glassy solid morphology. Without being bound by theory, the present invention includes a method of synthesizing an amorphous solid-state electrolyte comprising: (a) providing at least one precursor; (b) preparing the at least one precursor for plasma-processing by milling, grinding, mixing, alloying, and/or high shear mixing; and (c) plasma-processing the at least one precursor to melting prior to forming the amorphous solid-state electrolyte, wherein the plasma-processing includes at least providing a plasma gas and an excitation source to produce a plasma and providing a carrier gas to carry the at least one precursor through the plasma, (d) quenching the amorphous solid-state electrolyte and/or unreacted precursor. The method also includes wherein the solid-state electrolyte is an amorphous composition or a combination of amorphous compositions. The present invention also includes a method of synthesizing an amorphous composition comprising: (a) providing at least one precursor; (b) preparing the at least one precursor for plasma-processing by milling, grinding, mixing, alloying, and/or high shear mixing; and (c) plasma-processing the at least one precursor to melting prior to forming the amorphous composition, wherein the plasma-processing includes at least providing a plasma gas and an excitation source to produce a plasma and providing a carrier gas to carry the at least one precursor through the plasma, (d) quenching the amorphous composition and/or unreacted precursor. Thus, the present invention may also broadly include a composition comprising an amorphous solid-state electrolyte, wherein the amorphous solid-state electrolyte is prepared by plasma-processing. The amorphous solid-state electrolyte may comprise or be characterized by glassy, glassy phase, or glassy solid morphology. The amorphous composition and/or amorphous solid-state electrolyte may be substantially free of oxides (i.e., less than about 5%, less than about 4%, less than about 3%, less than about 2%, less than about 1%, less than about 0.5%, and/or an undetectable amount of oxides), as confirmed by powder XRD.

In another aspect, the present invention provides a method of synthesizing a composition comprising: (a) providing at least one precursor; (b) preparing the at least one precursor for plasma-processing by milling, grinding, mixing, alloying, and/or high shear mixing; and (c) plasma-processing the at least one precursor to form the composition, wherein the plasma-processing includes at least providing a plasma gas and an excitation source to produce a plasma and providing a carrier gas to carry the at least one precursor through the plasma. For example, the synthesized composition may be or may comprise Lithium Sulfide (Li₂S) and the at least one precursor may comprise Lithium Carbonate (Li₂CO₃) and/or Sulfur (S). In another embodiment, the synthesized composition may be or may comprise a non-lithium electrolyte or other alkali metal containing electrolyte, and the at least one precursor may comprise Sodium (Na), Potassium (K), and combinations thereof.

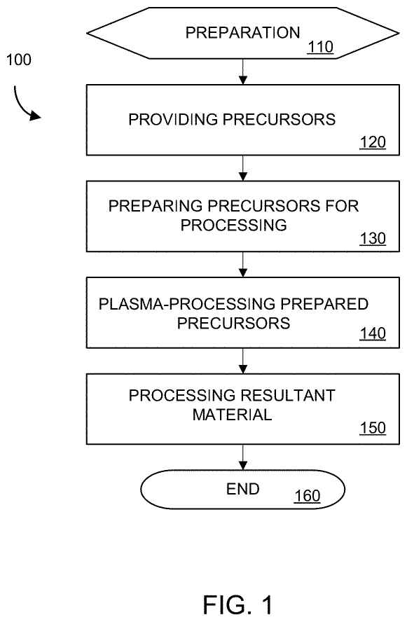

FIG. 1 is a flow chart of a process for plasma-assisted synthesis of solid-state electrolyte materials useful for the construction of secondary (e.g., rechargeable) electrochemical battery cells. Process 100, for example, results in highly lithium-ion-conducting crystalline, glass, and/or glass ceramic materials useful as solid-state electrolytes in lithium-based solid-state electrochemical cells. Process 100 may begin with preparation step 110 wherein any preparation action, such as precursor synthesis, purification, and equipment preparation may take place. It should be recognized that some preprocessing may also occur in a separate process from the plasma-process and such processed materials used in the method.

After any initial preparation or otherwise access to prepared materials, process 100 involves operation 120 where one or more precursors may be provided in amounts by weight and/or molar volume. Solid-state electrolyte precursors may include at least one lithium containing material. In some embodiments, the solid-state electrolyte precursors may further include at least one phosphorus containing material, at least one sulfur containing material, at least one halogen containing material, or combinations thereof.

In some embodiments, the lithium containing material may be or may comprise one or more of Li₂S, Li₂O, Li₂CO₃, Li₂SO₄, LiNO₃, Li₃N, Li₂NH, LiOH, LiNH₂, LiF, LiCl, LiBr, or LiI. In preferred embodiments, the lithium containing material is one or more of Li₂S, Li₂CO₃, or Li₂SO₄.

In some embodiments, the phosphorous containing materials may be at least one a phosphorous sulfide material, such as P₄Sₓ where 3≤x≤10, or more specifically P₄S₄, P₄S₅, P₄S₆, P₄S₇, P₄S₈, P₄S₉, or P₄S₁₀ (P₂S₅). In another embodiment, the phosphorous containing materials may be at least one a phosphorus nitrogen compound, for example, but not limited to, P₃N₅. In another embodiment, the phosphorous containing materials may be at least one a phosphorus oxygen compound, for example but not limited to P₂O₅. In still other embodiments, the phosphorous containing material may be or may comprise elemental phosphorous. In a preferred embodiment, the phosphorous containing material is P₄S₁₀ (P₂S₅) or comprises P₄S₁₀ (P₂S₅).

In some embodiments, the sulfur containing material may be or may comprise one or more of an alkali sulfide for example, but not limited to Li₂S, Na₂S, or K₂S. In another embodiment, the sulfur containing material may be one or more of an alkaline earth sulfide for example, but not limited to BeS, MgS, CaS, SrS, or BaS. In another embodiment, the sulfur containing material may one or more of a transition metal sulfide for example, but not limited to TiS₂, ZrS₂, WS₂, FeS₂, NiS₂, CuS₂, AgS, or ZnS. In another embodiment, the sulfur containing material may be one or more of a post-transition metal sulfide for example, but not limited to Al₂S₃, Ga₂S₃, SnS₂, or Sn₂S₃. In another embodiment, the sulfur containing material may be one or more of a metalloid sulfide for example, but not limited to B₂S₃, SiS₂, GeS₂, Sb₂S₃, or Sb₂S₅. In some embodiments, the sulfur containing material may be or may comprise elemental sulfur. In preferred embodiments, the sulfur containing material is or may comprise one or more of Li₂S, GeS₂, and SiS₂.

In some embodiments, the halogen containing material may be or may comprise one or more of a lithium halide, such as LiF, LiCl, LiBr, or LiI. In another embodiment, the halogen containing material may be one or more of a sodium halide, such as NaF, NaCl, NaBr or NaI. In another embodiment, the halogen containing material may be one or more of a boron halide, for example, but not limited to BCl₃, BBr₃, BI₃. In another embodiment, the halogen containing material may be or may comprise one or more of an aluminum halide, for example, but not limited to AlF₃, AlBr₃, AlI₃, or AlCl₃. In another embodiment, the halogen containing material may be or may comprise one or more of a silicon halide, for example, but not limited to SiF₄, SiCl₄, SiCl₃, Si₂Cl₅, SiBr₄, SiBrCl₃, SiBr₂Cl₂, or SiI₄. In another embodiment, the halogen containing material may be or may comprise one or more of a phosphorus halide, for example, but not limited to PF₃, PF₅, PCl₃, PCl₅, POCl₃, PBr₃, POBr₃, PI₃, P₂Cl₄, P₂I₄. In another embodiment, the halogen containing material may be or may comprise one or more of a sulfur halide, for example, but not limited to SF₂, SF₄, SF₆, S₂FI₀, SCl₂, S₂Cl₂, or S₂Br₂. In another embodiment, the halogen containing material may be or may comprise one or more of a germanium halide, for example, but not limited to GeF₄, GeCl₄, GeBr₄, GeI₄, GeF₂, GeCl₂, GeBr₂, or GeI₂. In another embodiment, the halogen containing material may be or may comprise one or more of an arsenic halide, for example, but not limited to AsF₃, AsCl₃, AsBr₃, AsI₃, AsF₅. In another embodiment, the halogen containing material may be or may comprise one or more of a selenium halide for example, but not limited to SeF₄, SeFe₆, SeCl₂, SeCl₄, Se₂Br₂, or SeBr₄; tin halide for example, but not limited to SnF₄, SnCl₄, SnBr₄, SnI₄, SnF₂, SnCl₂, SnBr₂, or SnI₂. In another embodiment, the halogen containing material may be or may comprise one or more of an antimony halide for example, but not limited to SbF₃, SbCl₃, SbBr₃, SbI₃, SbF₅, SbCl₅. In another embodiment, the halogen containing material may be or may comprise one or more of a tellurium halide for example, but not limited to TeF₄, Te₂F₁₀, TeF₆, TeCl₂, TeCl₄, TeBr₂, TeBr₄, or TeI₄. In another embodiment, the halogen containing material may be or may comprise one or more of a lead halide for example, but not limited to PbF₄, PbCl₄, PbF₂, PbCl₂, PbBr₂, or PbI₂. In another embodiment, the halogen containing material may be or may comprise one or more of a bismuth halide for example, but not limited to BiF₃, BiCl₃, BiBr₃, or BiI₃. In another embodiment, the halogen containing material may be or may comprise one or more of an yttrium halide for example, but not limited to YF₃, YCl₃, YBr₃, or YI₃. In another embodiment, the halogen containing material may be or may comprise one or more of a magnesium halide for example, but not limited to MgF₂, MgCl₂, MgBr₂, or Mg₂. In another embodiment, the halogen containing material may be or may comprise one or more transition metal halides. In another embodiment, the halogen containing material may be or may comprise one or more of a zirconium halide for example, but not limited to ZrF₄, ZrCl₄, ZrBr₄, or ZrI₄. In another embodiment, the halogen containing material may be or may comprise one or more lanthanide halides. In another embodiment, the halogen containing material may be or may comprise one or more of a lanthanum halide for example, but not limited to LaF₃, LaCl₃, LaBr₃, or LaI₃. In preferred embodiments, the halogen containing material is one or more of LiF, LiCl, LiBr, or LiI.

In some embodiments, the halogen containing material may comprise one or more pseudohalogens. In some embodiments, pseudohalogens may include BH₄, BF₄, OCN, CN, SCN, SH, NO, or NO₂. In some embodiments, the halogen containing material may include LiBH₄, LiBF₄, LiOCN, LiCN, LiSCN, LiSH, LiNO, or LiNO₂. In some embodiments, the halogen containing material may include NaBH₄, NaBF₄, NaOCN, NaCN, NaSCN, NaSH, NaNO, or NaNO₂.

In some aspects, the halogen containing material may be or may comprise a compound having the general formula LiX₍₁₋ₐ₎Yₐ, wherein the X and Y include halogens, such as F, Cl, Br, or I, and/or pseudohalogens, such as BH₄, BF₄, OCN, CN, SCN, SH, NO, or NO₂ where 0≤a≤1.

In operation 130, the precursors may be prepared for plasma processing by way of mixing, solution processing, alloying, such as but not limited to mechanical alloying, and/or by various particle-size reduction techniques, alone or in various possible combinations, including milling, grinding, high shear mixing, thermal treating and other methods to reduce the particle size of the precursors. Mixing the precursors is critical to forming a homogeneous composite material and ensuring the proper molar ratio of precursors is delivered to the plasma, thus resulting in a higher-purity product. Precursor particle size may include a range of 1 nm to 10 mm. As used herein, “particle size” refers to the average particle size as measured by the diameter of the particles. Methods of measuring particle size are known in the art. Smaller particle sizes are preferred, as smaller particle sizes allow for better control of the ratio of reactants entering the plasma chamber. The particle size of at least one of the precursors may be reduced prior to plasma-processing. In some embodiments, the particle size of all of the precursors may be reduced prior to plasma processing. In some embodiments, operation 130 is performed without any chemical reactions occurring. In other embodiments, some chemical reactions may occur in operation 130. In some embodiments, operation 130 may be optional and/or may not be performed. In some embodiments, there may be no mixing, milling, grinding, alloying, high shear mixing, thermal treating, and/or other methods to reduce the particle size of the precursors prior to the plasma-processing.

In some embodiments, after particle-size reduction, the precursors may have a particle size from about 1 nm to about 10 mm. In some aspects, the precursors may have a particle size from about 1 nm to about 50 nm, about 1 nm to about 100 nm, about 1 nm to about 250 nm, about 1 nm to about 500 nm, about 1 nm to about 750 nm, about 1 nm to about 1 μm about 1 nm to about 10 μm, about 1 nm to about 50 μm, about 1 nm to about 100 μm, about 1 nm to about 250 μm, about 1 nm to about 500 μm, about 1 nm to about 750 μm, about 1 nm to about 1 mm, about 1 nm to about 5 mm, or about 1 nm to about 10 mm. In some additional aspects, the precursors may have a particle size from about 1 nm to about 50 nm, about 50 nm to about 100 nm, about 100 nm to about 250 nm, about 250 nm to about 500 nm, about 500 nm to about 750 nm, about 750 nm to about 1 μm, about 1 μm to about 10 μm, about 10 μm to about 50 μm, about 50 μm to about 100 μm, about 100 μm to about 250 μm, about 250 μm to about 500 μm, about 500 μm to about 750 μm, about 750 μm to about 1 mm, about 1 mm to about 5 mm, or about 5 mm to about 10 mm.

In some embodiments, all of the precursors may have a uniform particle size. Any of the particles described herein may be spherical, spheroidal, ellipsoidal, cylindrical, polyhedral, cube shaped, rod shaped, disc shaped, or irregularly shaped. In other embodiments, one or more precursors may have a larger or smaller particle size as compared to the other precursors. Varying the particle size of the precursors may be advantageous when the precursors have substantially different melting points and/or boiling points. For example, a precursor particle with a low melting point and boiling point may substantially or completely evaporate before reacting with the remaining precursors if the particle size of the precursor is small. Thus, the particle size of the precursors may be modified to increase reaction yields.

In some embodiments, the processing in operation 130 may occur in a solvent-free environment; i.e., the mixing, milling, grinding, alloying, high shear mixing, thermal treating, or other methods to reduce the particle size of the precursors is performed in the absence of a solvent. This results not only in a solvent-free process, but also ensures that the end product is free of any solvent as well. As defined herein, “solvent-free” means that there is no solvent or essentially no solvent used in the process or present in the product produced from the process. Solvent-free may also mean in the absence of a slurry and/or without requiring the formation of a slurry. Solvent-free also may mean substantially free of any solvent impurities (e.g., less than or equal to 30%, 25%, 20%, 15%, 10%, 5%, 4%, 3%, 2%, 1%, or 0.5% of any solvent-related impurities). The term “material” may be used interchangeably with “composition of matter.”

In other embodiments, the processing in operation 130 occurs in the presence of a solvent. As used herein, the term “solvent” can refer to a liquid that dissolves one or more components of a mixture, or it may refer to a liquid that acts as a carrier fluid and does not dissolve any components of a mixture. In some aspects, the solvent may be an aprotic solvent. In some aspects, the solvent may be a protic solvent. In some particular aspects, the solvent may be a non-polar hydrocarbon, including but not limited to benzene, toluene, xylenes, C₁-C₁₂ alkanes (including substituted or unsubstituted alkanes), and other non-polar hydrocarbons known in the art. In some aspects, the C₁-C₁₂ alkane may be heptane or octane.

In operation 140, the prepared precursors may be processed with the assistance of plasma-based systems and methods. The plasma-processing may include providing a carrier gas to transport the selected precursors and to support the existence of the plasma. The plasma may heat the carrier gas and the precursors to induce formation of the solid-state electrolyte materials. For excitation of the plasma, an excitation source may be provided. The plasma excitation source, for example, may be one or more of an AC discharge, a DC discharge, a laser discharge, a radio frequency (RF) source, a microwave (MW) source and/or other energy sources that may induce and/or support the plasma. The plasma may be contained within a plasma flow reactor or other type of plasma system. At least portions of the carrier gas and/or the precursors may be in the actual plasma state (i.e., ionized) whereas other materials may be in a fluidized state in the heated carrier gas.

The carrier gas may be a non-reactive carrier gas, a reactive carrier gas, or a combination thereof, which is supplied at a flow rate suitable to support the movement of the precursor(s) through the plasma-processing and to support the formation of the desired solid-state electrolyte materials. The non-reactive carrier gas may be considered as a carrier gas that does not itself engage in chemical interactions with the precursors during processing. For example, inert gasses such as argon, helium, neon, krypton, xenon, and combinations thereof may be used as non-reactive carrier gasses. In preferred embodiments, the inert gas may be or may comprise argon. A reactive carrier gas may be considered as a carrier gas that does chemically interact with the precursors during the plasma-processing. This may include direct chemical interactions involving the sharing of atomic species or catalytic activity imparted upon the precursors by the gas. In some embodiments, the reactive carrier gas may be one or more of a sulfur containing gas, for example, but not limited to hydrogen sulfide, sulfur vapor, sulfur hexafluoride, and combinations thereof. In another embodiment, the reactive carrier gas may be one or more of an oxygen containing gas, for example, but not limited to water, oxygen, ozone, and combinations thereof. In another embodiment, the reactive carrier gas may be one or more of a nitrogen containing gas, for example, but not limited to ammonia, nitric oxide (NO₂, N₂O₄), and nitrogen gas. In another embodiment, the reactive carrier gas may be one or more of a halogen containing gas, for example, but not limited to chloride gas (Cl₂), bromine gas (Br₂), iodine gas (I₂), hydrogen chloride, hydrogen bromide, and combinations thereof. In other embodiments, the reactive carrier gas may be a hydrocarbon, for example, but not limited to, methane. Carrier gasses may also function to form intermediate compounds during the processing of the precursors into the desired final products. Some gases, such as nitrogen, may be reactive or non-reactive depending on the precursor composition and the plasma-assisted processing conditions. In preferred embodiments, the reactive carrier gas may be or may comprise one or more of ammonia, sulfur, hydrogen sulfide, nitrogen, methane, and combinations thereof.

The carrier gas pressure, flow rate, and species may be varied to adjust precursor heating, reaction kinetics, volume fraction and/or resultant solid-state electrolyte materials particle size.

In some embodiments, the carrier gas may have a flow rate of at least about 0.1 liters per minute per gram of precursors being plasma-processed. In some aspects, the carrier gas may have a flow rate of at least about 0.1, at least 0.2, at least 0.3, at least 0.4, at least 0.5, at least 0.6, at least 0.7, at least 0.8, at least 0.9, at least 1.0, at least 2.0, at least 3.0, at least 4.0, at least 5.0, at least 6.0, at least 7.0, at least 8.0, at least 9.0, or at least 10.0 liters per minute per gram of precursors being plasma-processed.

In additional embodiments, the carrier gas may have a flow rate from about 0 to about 100 liters per minute. In some aspects, the carrier gas may have a flow rate from about 0 liters per minute to about 10 liters per minute, about 0 liters per minute to about 20 liters per minute, about 0 liters per minute to about 30 liters per minute, about 0 liters per minute to about 40 liters per minute, about 0 liters per minute to about 50 liters per minute, about 0 liters per minute to about 60 liters per minute, about 0 liters per minute to about 70 liters per minute, about 0 liters per minute to about 80 liters per minute, about 0 liters per minute to about 90 liters per minute, about 10 liters per minute to about 100 liters per minute, about 20 liters per minute to about 100 liters per minute, about 30 liters per minute to about 100 liters per minute, about 40 liters per minute to about 100 liters per minute, about 50 liters per minute to about 100 liters per minute, about 60 liters per minute to about 100 liters per minute, about 70 liters per minute to about 100 liters per minute, about 80 liters per minute to about 100 liters per minute, about 90 liters per minute to about 100 liters per minute, about 10 liters per minute liters per minute to about 20 liters per minute, about 20 liters per minute to about 30 liters per minute, about 30 liters per minute to about 40 liters per minute, about 40 liters per minute to about 50 liters per minute, about 50 liters per minute to about 60 liters per minute, about 60 liters per minute to about 70 liters per minute, about 70 liters per minute to about 80 liters per minute, about 80 liters per minute to about 90 liters per minute, or about 90 liters per minute to about 100 liters per minute. In some aspects, the carrier gas may have a flow rate of greater than 0 liters per minute. In some additional aspects, the carrier gas may have a flow rate of greater than 100 liters per minute.

In some embodiments, the carrier gas pressure may be from about 1×10⁻⁹ Torr to about 7600 Torr. In some aspects, the carrier gas pressure may be from about 1×10⁻⁹ Torr to about 1×10⁻⁸ Torr, about 1×10⁻⁹ Torr to about 1×10⁻⁷ Torr, about 1×10⁻⁹ Torr to about 1×10⁻⁶ Torr, about 1×10⁻⁹ Torr to about 1×10⁻⁵ Torr, about 1×10⁻⁹ Torr to about 1×10⁻⁴ Torr, about 1×10⁻⁹ Torr to about 1×10⁻³ Torr, about 1×10⁻⁹ Torr to about 1×10⁻² Torr, about 1×10⁻⁹ Torr to about 1×10⁻¹ Torr, about 1×10⁻⁹ Torr to about 1 Torr, about 1×10⁻⁹ Torr to about 10 1×10⁻⁹ Torr, about 1×10⁻⁹ Torr to about 100 Torr, about 1×10⁻⁹ Torr to about 500 Torr, about 1×10⁻⁹ Torr to about 1000 Torr, about 1×10⁻⁹ Torr to about 5000 Torr, about 1×10⁻⁸ Torr to about 7600 Torr, about 1×10⁻⁷ Torr to about 7600 Torr, about 1×10⁻⁶ Torr to about 7600 Torr, about 1×10⁻⁵ Torr to about 7600 Torr, about 1×10⁻⁴ Torr to about 7600 Torr, about 1×10⁻³ Torr to about 7600 Torr, about 1×10⁻² Torr to about 7600 Torr, about 1×10⁻¹ Torr to about 7600 Torr, 1 Torr to about 7600 Torr, about 10 Torr to about 7600 Torr, about 100 Torr to about 7600 Torr, about 500 Torr to about 7600 Torr, about 1000 Torr to about 7600 Torr, about 5000 Torr to about 7600 Torr, about 1 Torr to about 1000 Torr, about 10 Torr to about 1000 Torr, about 100 Torr to about 1000 Torr, about 500 Torr to about 1000 Torr, about 1 Torr to about 500 Torr, about 10 Torr to about 500 Torr, or about 100 Torr to about 500 Torr. In some embodiments, the carrier gas pressure may be greater than 7600 Torr.

Varying the parameters of the carrier and reactive gases changes the fluidization of the precursors and the resultant density of precursors undergoing plasma processing. This, in-turn, alters the thermal dynamics and the processing time and temperature requirements. Proper selection of the reaction temperature and duration of reaction avoids the creation of undesired products and provides for a very fast synthesis. Additionally, many precursor materials and reaction products, especially sulfide materials, may react strongly with metals, such as stainless steel, aluminum, nickel, iron, chrome, etc. that can result in contamination of the products. Processing in a fluidized and/or gaseous state avoids this issue.

Excitation of the plasma may be adjusted to achieve an effective heating temperature from about 70° C. to about 1200° C. As used herein “effective heating temperature” refers to the average temperature of the particles flowing through the plasma, rather than the temperature of the plasma itself. It will be noted that the plasma may have a temperature as high as 4,000 K. In some embodiments, the effective heating temperature may range from about 70° C. to about 100° C., about 70° C. to about 150° C., about 70° C. to about 200° C., about 70° C. to about 250° C., about 70° C. to about 300° C., about 70° C. to about 350° C., about 70° C. to about 400° C., about 70° C. to about 450° C., about 70° C. to about 500° C., about 70° C. to about 550° C., about 70° C. to about 600° C., about 70° C. to about 650° C., about 70° C. to about 600° C., about 70° C. to about 650° C., about 70° C. to about 700° C., about 70° C. to about 750° C., about 70° C. to about 800° C., about 70° C. to about 850° C., about 70° C. to about 900° C., about 70° C. to about 950° C., about 70° C. to about 1000° C., about 70° C. to about 1100° C., about 100° C. to about 1200° C., about 150° C. to about 1200° C., about 200° C. to about 1200° C., about 250° C. to about 1200° C., about 300° C. to about 1200° C., about 350° C. to about 1200° C., about 400° C. to about 1200° C., about 450° C. to about 1200° C., about 500° C. to about 1200° C., about 550° C. to about 1200° C., about 600° C. to about 1200° C., about 650° C. to about 1200° C., about 700° C. to about 1200° C., about 750° C. to about 1200° C., about 800° C. to about 1200° C., about 850° C. to about 1200° C., about 900° C. to about 1200° C., about 950° C. to about 1200° C., about 1000° C. to about 1200° C., about 1100° C. to about 1200° C., about 100° C. to about 1100° C., about 200° C. to about 1000° C., about 300° C. to about 900° C., about 400° C. to about 800° C., or about 500° C. to about 700° C. In some embodiments, the effective heating temperature may be greater than about 70° C. In some embodiments, the effective heating temperature may be greater than 1200° C. In some embodiments, excitation of the plasma may be adjusted to achieve an effective heating temperature from about 70° C. to about 1500° C., about 1000° C. to about 2000° C., about 70° C. to about 2000° C., about 2000° C. to about 3000° C., about 70° C. to about 3000° C., about 3000° C. to about 4000° C., about 70° C. to about 4000° C., about 4000° C. to about 5000° C., or about 70° C. to about 5000° C. In some embodiments, the effective heating temperature may be greater than about 5000° C. It will be appreciated by those having ordinary skill in the art that different materials may be heated to different effective heating temperatures during the plasma processing based on factors including the heat capacity of the material, thermal conductivity of the material, flow rate of the material through the plasma, particle size of the material etc.

The heating may specifically reach a crystallization temperature of a desired solid-state electrolyte material and maintain that temperature for a period of, for example, greater than about 1 microsecond to about 60 seconds to support formation of the desired material. In some aspects, the crystallization temperature may be maintained for a fast reaction period from about 1 microsecond to about 10 microseconds, about 1 microsecond to about 100 microseconds, about 1 microsecond to about 1 millisecond, about 1 microsecond to about 10 milliseconds, about 1 microsecond to about 100 milliseconds, about 1 microsecond to about 1 second, about 1 microsecond to about 10 seconds, about 1 microsecond to about 30 seconds, about 10 microseconds to about 60 seconds, about 100 microseconds to about 60 seconds, about 1 millisecond to about 60 seconds, about 10 milliseconds to about 60 seconds, about 100 milliseconds to about 60 seconds, about 1 second to about 60 seconds, about 10 seconds to about 60 seconds, about 30 seconds to about 60 seconds. In some aspects, the crystallization temperature may be maintained for a fast reaction period from about 10 microseconds to about 1 seconds, about 100 microseconds to about 1 second, about 1 millisecond to about 1 second, about 10 milliseconds to about 1 second, about 100 milliseconds to about 1 second, about 10 microseconds to about 100 milliseconds, about 10 microseconds to about 10 milliseconds, about 10 microseconds to about 1 millisecond, or about 10 microseconds to about 100 microseconds. In some preferred embodiments, the crystallization temperature may be maintained for a period from about 10 milliseconds to about 3 seconds, or more preferably from about 100 milliseconds to about 2 seconds, or even more preferably from about 100 milliseconds to about 1 second.

In some embodiments, the resultant solid-state electrolyte materials may have a particle size from about 1 nm to about 10 mm. In some aspects, the resultant solid-state electrolyte materials may have a particle size from about 1 nm to about 50 nm, about 1 nm to about 100 nm, about 1 nm to about 250 nm, about 1 nm to about 500 nm, about 1 nm to about 750 nm, about 1 nm to about 1 μm about 1 nm to about 10 μm, about 1 nm to about 50 μm, about 1 nm to about 100 μm, about 1 nm to about 250 μm, about 1 nm to about 500 μm, about 1 nm to about 750 μm, about 1 nm to about 1 mm, about 1 nm to about 5 mm, or about 1 nm to about 10 mm. In a particular embodiment, the resultant solid-state electrolyte materials have a particle size of about 1 μm to about 5 μm, preferably about 3 μm.

Resultant solid-state electrolyte materials may be further processed in step 150 and, for example, incorporated into electrochemical cells. In some embodiments, step 150 may include reducing the particle size of the solid-state electrolyte materials such as by milling, grinding, high shear mixing, thermal treating and other methods. In some embodiments, step 150 may include washing the solid-state electrolyte materials. In still further embodiments, step 150 may include coating the solid-state electrolyte materials.

In some embodiments, the resultant solid-state electrolyte materials may have a purity of about 30% by weight or greater. In some aspects, the resultant solid-state electrolyte materials may have a purity of about 30% to about 40%, about 30% to about 50%, about 30% to about 60%, about 30% to about 70%, about 30% to about 80%, about 30% to about 90%, about 30% to about 95%, about 30% to about 99%, about 30% to about 99.9%, about 40% to about 99.9%, about 50% to about 99.9%, about 60% to about 99.9%, about 70% to about 99.9%, about 80% to about 99.9%, about 90% to about 99.9%, about 40% to about 50%, about 50% to about 60%, about 60% to about 70%, about 70% to about 80%, about 80% to about 90%, about 90% to about 95%, or about 95% to about 99.9% by weight. In some exemplary embodiments, the solid-state electrolyte materials may have a purity of greater than about 80% by weight, greater than about 90% by weight, greater than about 95% by weight, greater than about 99% by weight, or greater than about 99.9% by weight.

In some embodiments, the solid-state electrolyte materials made by the process 100 may include lithium rich anti-perovskite (LiRAP) materials. The LiRAP materials may include, but are not limited to Li₃OCl, Li₃OBr, Li3OI, Li3SCl, Li3SBr, Li3SI, and their solid solutions.

In some embodiments, the solid-state electrolyte materials made by the process 100 may include sulfide electrolyte materials, such as but not limited to lithium-boron-sulfur (LBS) materials. In some aspects, the LBS materials may include, but are not limited to Li₃BS₃, Li₂B₂S₅, Li₅B₇S₁₃, and Li₉B₁₉S₃₃.

In additional embodiments, the solid-state electrolyte materials made by the process 100 may include sulfide electrolyte materials that contain phosphorus and/or a halogen (LPSX Materials). In some aspects, the LPSX materials may include, but are not limited to Li₆PS₅Cl, Li₆PS₅Br, Li₆PS₅Cl_{0.5}Br_{0.5}, Li₇P₂S₈Cl, Li₇P₂S₈Br, Li₇P₂S₈I, Li₇P₂S₈Cl_{0.5}Br_{0.5}, Li_{7-a-b}PS_{6-(a+b)}XₐY_{b} or Li₇P₂S₈XₐY_{b}, where X and Y includes a halogen, such as F, Cl, Br, or I or pseudohalogens, such as BH₄, BF₄, OCN, CN, SCN, SH, NO, or NO₂ where 0≤a≤2 and 0≤b≤2.

In some embodiments, the reaction for producing the desired solid-state electrolyte material may include, but is not limited to the following:

Li₂S—P₂S₅—LiX

where X includes a halogen, such as F, Cl, Br, or I or pseudohalogens, such as BH₄, BF₄, OCN, CN, SCN, SH, NO, or NO₂.

Li₂S+P₂S₅+LiX+LiY→Li_{7-a-b}PS_{6-(a+b)}XₐY_{b}

where X and Y includes a halogen, such as F, Cl, Br, or I or pseudohalogens, such as BH₄, BF₄, OCN, CN, SCN, SH, NO, or NO₂ where 0≤a≤2 and 0≤b≤2.

5Li₂S+P₂S₅+2LiCl→2Li₆PS₅Cl

5Li₂S+P₂S₅+2LiBr→2Li₆PS₅Br

5Li₂S+P₂S₅+LiCl+LiBr→2Li₆PS₅Cl_{0.5}Br_{0.5}

Li₂S+P₂S₅+LiX+LiY→Li₇P₂S₈XₐY_{b}

where X and Y includes a halogen, such as F, Cl, Br, or I or pseudohalogens, such as BH₄, BF₄, OCN, CN, SCN, SH, NO, or NO₂.

3Li₂S+P₂S₅+LiCl→Li₇P₂S₈Cl

3Li₂S+P₂S₅+LiBr→Li₇P₂S₈Br

3Li₂S+P₂S₅+LiI→Li₇P₂S₈I

3Li₂S+P₂S₅+LiBr+LiCl→Li₇P₂S₈Cl_{0.5}Br_{0.5}

Li₂S—B₂S₃

3Li₂S+B₂S₃→Li₃BS₃

Li₂S+B₂S₃+S→Li₂B₂S₅

5Li₂S+7B₂S₃→2Li₅B₇S₁₃

5Li₂S+5B₂S₃→Li₁₀B₁₀S₂₀

9Li₂S+19B₂S₃→2Li₉B₁₉S₃₃

LiCl+Li₂O→Li₃OCl

LiCl+2LiOH→Li₃OCl+H₂O

Other acceptable materials include Li₂S—P₃N₅, Li₂S—P₃N₅—P₂S₅, Li₂S—P₃N₅—P₂S₅—LiX, Li₂S—Li₃N—P₂S₅—LiX, or Li₂S—Li₃N—P₂S₅. Any of the chemical reactions described herein may be produced in a solvent free manner and/or in a fast reaction period of time.

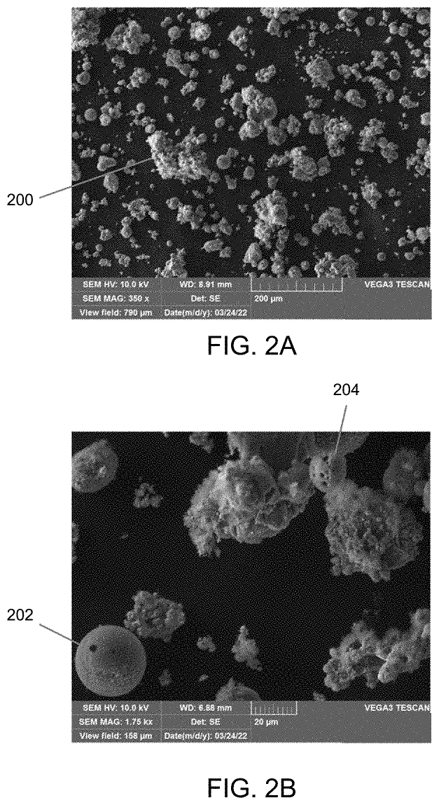

In some embodiments, the resultant solid-state electrolyte materials made by the process may have a substantially round shape, as confirmed by scanning electron microscopy. When the precursors enter the plasma chamber, they have a jagged, rough appearance as shown in FIG. 2A. If the precursors are not are not in the hot zone for a sufficient duration, the precursors may not melt, sinter, crystallize, or volatilize and may maintain the jagged shape 200.

If the precursors are in the hot zone for a sufficient duration, then the resultant solid-state electrolyte material may have a substantially round appearance 202 as shown in FIG. 2B. As used herein, particles having a “substantially round” appearance may include particles that are spherical, spheroidal, ellipsoidal, cylindrical, etc.

If the precursors are in the hot zone for an extended duration, or are heated above the crystallization temperature, the resultant solid-state electrolyte material may begin to volatilize and boil. This may cause the resultant solid-state electrolyte material to have a pitted appearance 204, as shown in FIG. 2B.

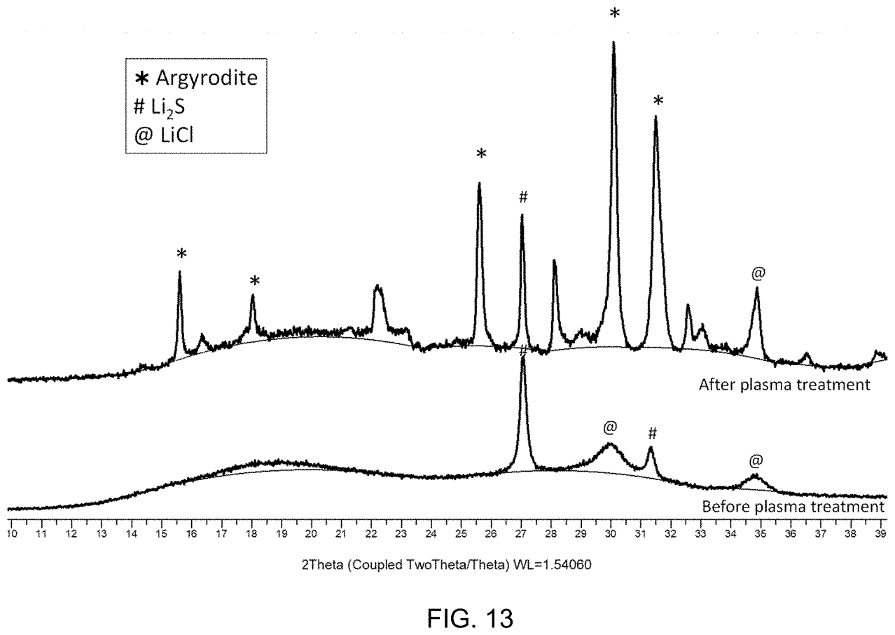

In some embodiments, the resultant material from the plasma processing 140 may have particle morphologies as shown in any one of FIGS. 13A-13K as determined by SEM.

It will be understood by those having ordinary skill in the art that other morphologies are possible, including acicular particles, faceted particles, etc., and that the particle morphologies presented are not particularly limiting.

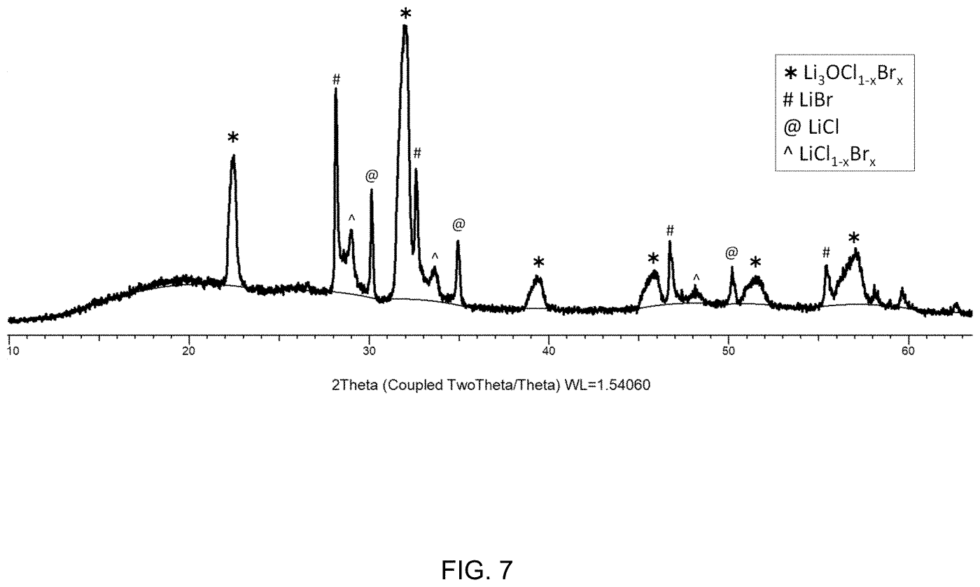

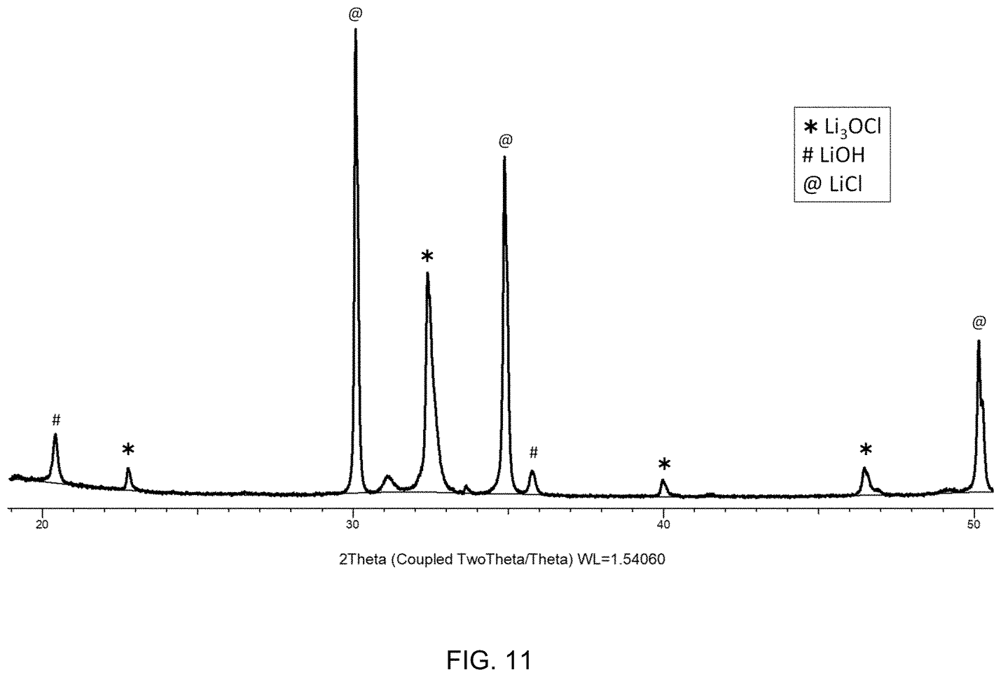

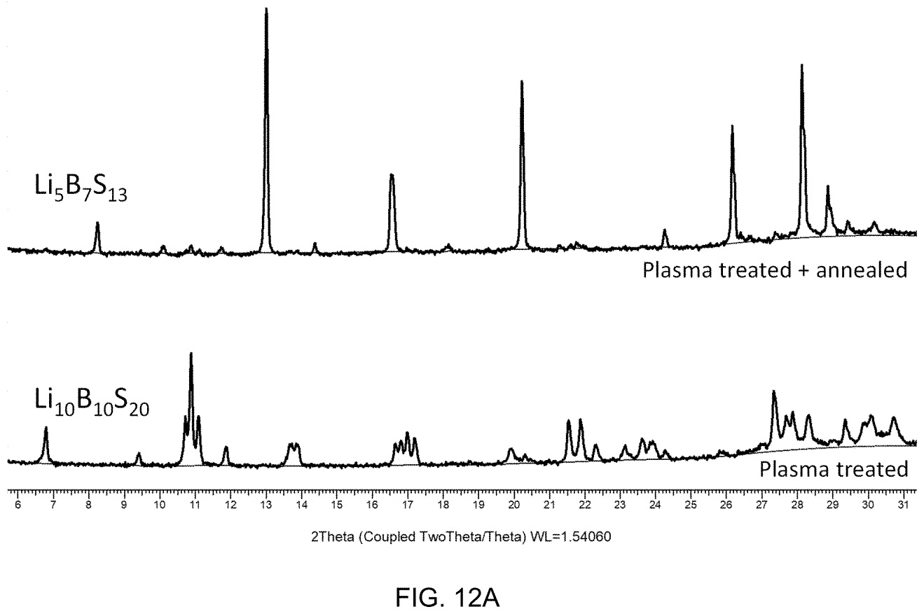

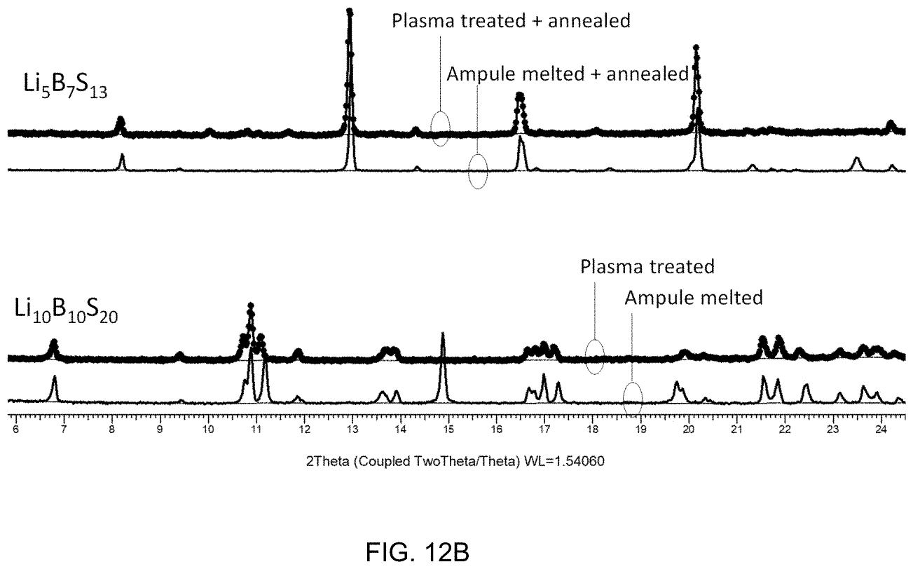

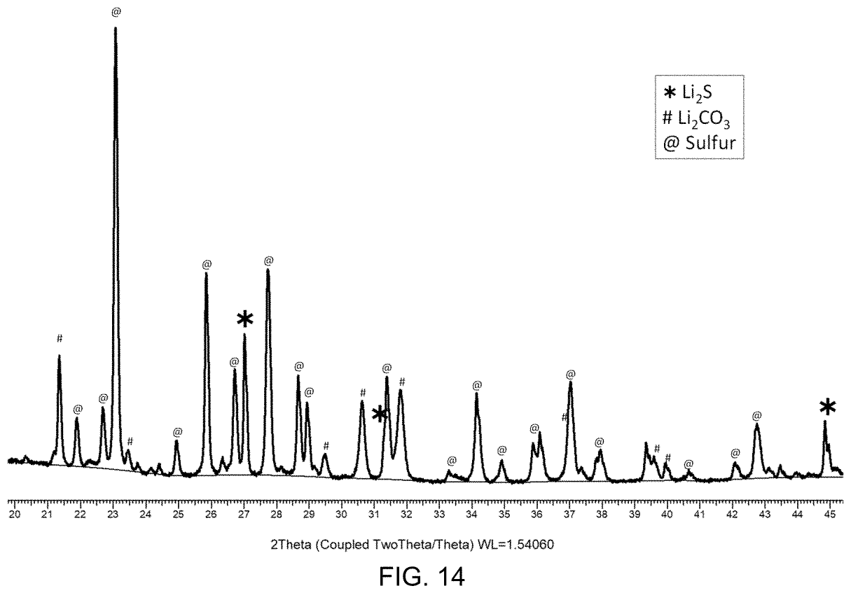

In some embodiments, the resultant material from the plasma processing 140 may have an XRD pattern as shown in FIG. 7. In some embodiments, the resultant material from the plasma processing 140 may have an XRD pattern as shown in FIG. 11. In some embodiments, the resultant material from the plasma processing 140 may have an XRD pattern as shown in FIG. 12A. In some embodiments, the resultant material from the plasma processing 140 may have an XRD pattern as shown in FIG. 12B. In some embodiments, the resultant material from the plasma processing 140 may have an XRD pattern as shown in FIG. 13. In some embodiments, the resultant material from the plasma processing 140 may have an XRD pattern as shown in FIG. 14.

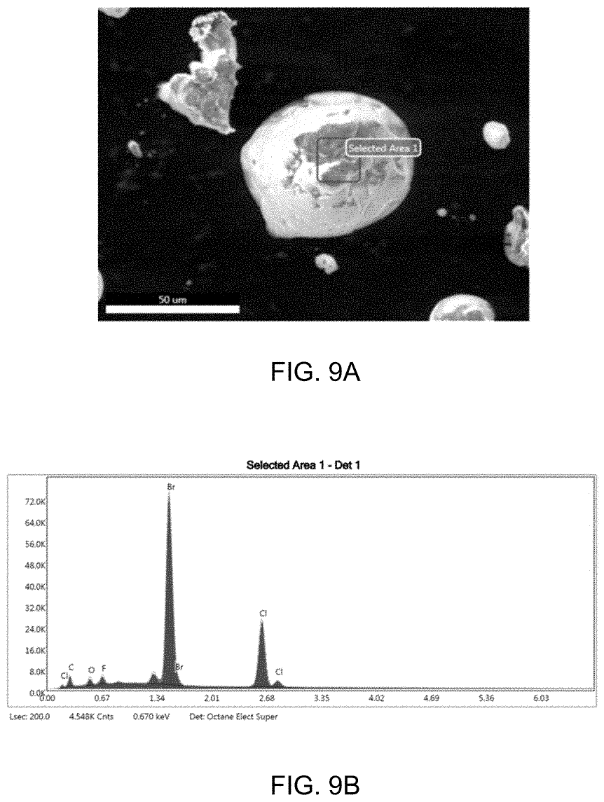

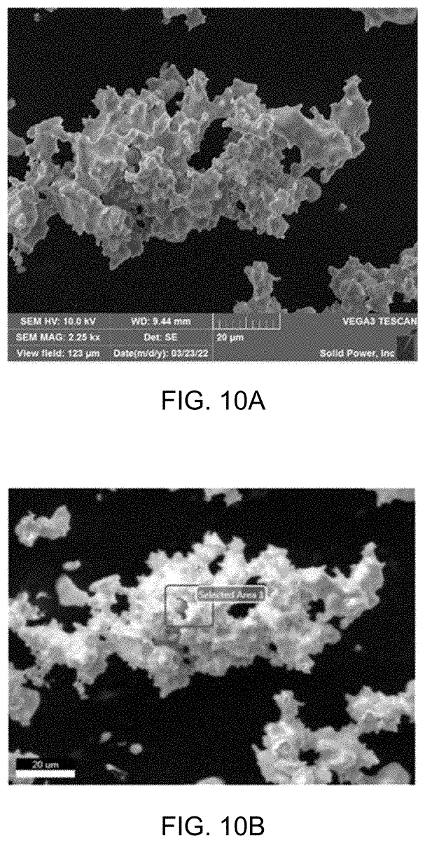

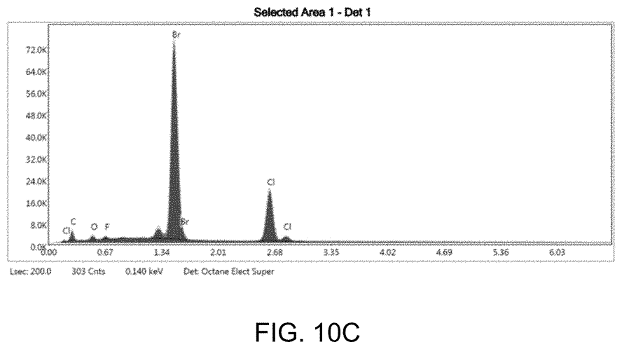

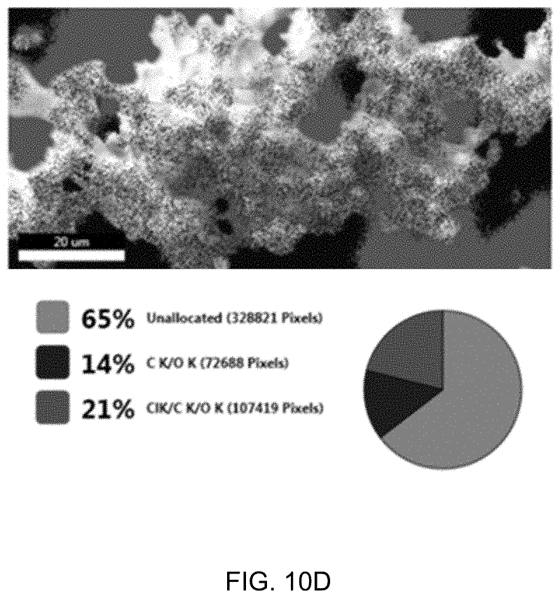

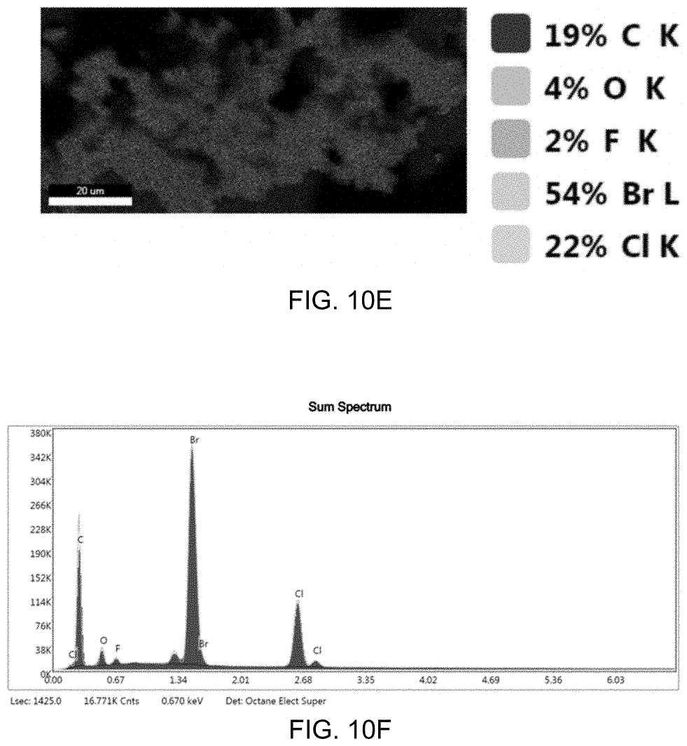

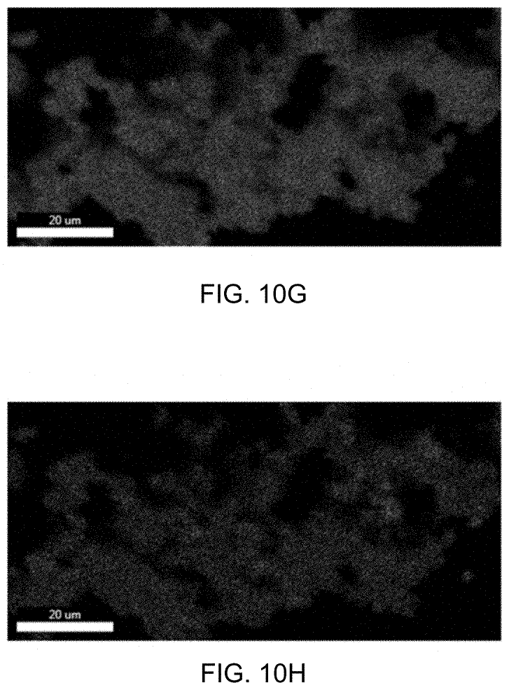

In some embodiments, the resultant material from the plasma processing 140 may have an EDS spectrum as shown in FIG. 9B. In some embodiments, the resultant material from the plasma processing 140 may have an EDS spectrum as shown in FIG. 10C. In some embodiments, the resultant material from the plasma processing 140 may have an EDS spectrum as shown in FIG. 10F.

In some embodiments, the resultant material from the plasma processing 140 may have an atom composition as shown in FIG. 10D as determined by EDS. In some embodiments, the resultant material from the plasma processing 140 may have an atom composition as shown in FIG. 10E as determined by EDS. In some embodiments, the resultant material from the plasma processing 140 may have an atom composition as shown in FIG. 10G as determined by EDS. In some embodiments, the resultant material from the plasma processing 140 may have an atom composition as shown in FIG. 10H as determined by EDS.

In some exemplary embodiments, the resultant material may include a eutectic material comprising LiCl₁₋ₓBrₓ where x may be 0 to 1. In some aspects, the eutectic comprises less than about 20%, less than about 15%, less than about 10%, less than about 5%, less than about 3%, less than about 2%, or less than about 1% of the resultant material by weight.

Process 100 terminates with step 160.

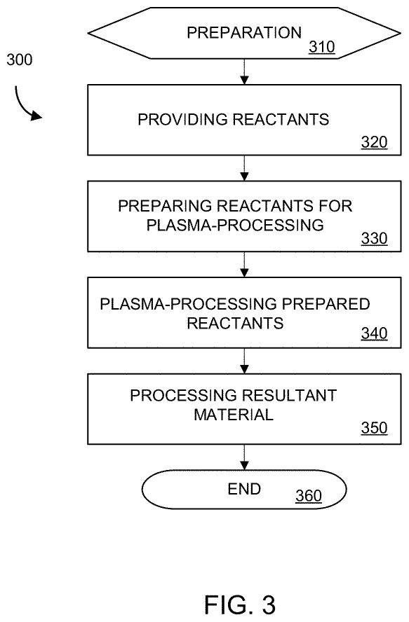

FIG. 3 is a flow chart of a process for plasma-assisted synthesis of precursors for synthesizing solid-state electrolyte materials. Process 300 may begin with preparation step 210 wherein any preparation action, such as purification, and equipment preparation may take place. It should be recognized that some preprocessing may also occur in a separate process from the plasma-process and such processed materials used in the method. It will also be understood that the preparation step 110 of process 100 in FIG. 1 may include process 300, i.e., synthesis of precursor materials.

After the initial preparation 310, process 300 involves operation 320 where one or more reactants may be provided in amounts by weight and/or molar volume. Reactants for precursor synthesis may include lithium containing reactants, phosphorus containing reactants, sulfur containing reactants, and other reactants for making precursors.

In some embodiments, the lithium containing reactants may include but are not limited to Li₂SO₄, LiOH, Li₂O, Li₂CO₃, LiNO₃, Li₃N, LiX, and LiY where X and Y include halogens, such as F, Cl, Br, or I, and pseudohalogens, such as BH₄, BF₄, OCN, CN, SCN, SH, NO, or NO₂. In some additional embodiments, the lithium containing reactants may include LiX₍₁₋ₐ₎Yₐ, wherein the X and Y include halogens, such as F, Cl, Br, or I, and/or pseudohalogens, such as BH₄, BF₄, OCN, CN, SCN, SH, NO, or NO₂ where 0≤a≤1

In some embodiments, the phosphorus containing reactants may include but are not limited to P₂S₅, P₂O₅, and elemental phosphorus.

In some embodiments, the sulfur containing reactants may include but are not limited to H₂S and elemental sulfur.

In some embodiments, the other reactants may include carbon, ammonium, and elemental boron.

In operation 330, the reactants may be prepared for plasma processing by way of mixing, alloying such as but not limited to mechanical alloying, solution processing, and by various particle-size reduction techniques, alone or in various possible combinations, including milling, grinding, high shear mixing, thermal treating, and other methods to reduce the particle size of the precursors. Reactant particle size may include a range from 1 nm to 10 mm. Smaller particle sizes are preferred, as smaller particle sizes allow for better control of the ratio of reactants entering the plasma chamber. The particle size of at least one of the reactants may be reduced prior to plasma-processing. In some embodiments, the particle size of all of the reactants may be reduced prior to plasma processing. In some embodiments, operation 330 is performed without any chemical reactions occurring. In other embodiments, some chemical reactions may occur in operation 330. In some embodiments, operation 330 may be optional and/or may not be performed. In some embodiments, there may be no mixing, milling, grinding, alloying, high shear mixing, thermal treating, and/or other methods to reduce the particle size of the precursors prior to the plasma-processing.

In some embodiments, after particle-size reduction, the reactants may have a particle size from about 1 nm to about 10 mm. In some aspects, the reactants may have a particle size from about 1 nm to about 50 nm, about 1 nm to about 100 nm, about 1 nm to about 250 nm, about 1 nm to about 500 nm, about 1 nm to about 750 nm, about 1 nm to about 1 μm about 1 nm to about 10 μm, about 1 nm to about 50 μm, about 1 nm to about 100 μm, about 1 nm to about 250 μm, about 1 nm to about 500 μm, about 1 nm to about 750 μm, about 1 nm to about 1 mm, about 1 nm to about 5 mm, or about 1 nm to about 10 mm.

In some embodiments, all of the reactants may have a uniform particle size. In other embodiments, one or more reactants may have a larger or smaller particle size as compared to the other reactants. Varying the particle size of the reactants may be advantageous when the reactants have substantially different melting points and/or boiling points. For example, a reactant particle with a low melting point and boiling point may substantially or completely evaporate before reacting with the remaining reactants if the particle size of the reactants is small. Thus, the particle size of the reactants may be modified to increase reaction yields.

In some embodiments, the processing in operation 330 may occur in a solvent-free environment; i.e., the mixing, alloying, milling, grinding, high shear mixing, thermal treating, or other methods to reduce the particle size of the precursors is performed in the absence of a solvent. This results not only in a solvent-free process, but also ensures that the end product is free of any solvent as well.

In other embodiments, the processing in operation 330 occurs in the presence of a solvent. In some aspects, the solvent may be an aprotic solvent. In some aspects, the solvent may be a protic solvent. In some particular aspects, the solvent may be a non-polar hydrocarbon, including but not limited to benzene, toluene, xylenes, C₁-C₁₂ alkanes, and other non-polar hydrocarbons known in the art. In some aspects, the C₁-C₁₂alkane may be heptane or octane.

In operation 340, the prepared reactants may be processed with the assistance of plasma-based systems and methods. The plasma-processing may include providing a carrier gas to transport the selected reactants and to support the existence of the plasma. The plasma may heat the carrier gas and the reactants to induce formation of the precursors. For excitation of the plasma, an excitation source may be provided. The plasma excitation source, for example, may be one or more of an AC discharge, a DC discharge, a laser discharge, a radio frequency (RF) source, a microwave (MW) source and/or other energy sources that may induce and/or support the plasma. The plasma may be contained within a plasma flow reactor or other type of plasma system. At least portions of the carrier gas and/or the precursors may be in the actual plasma state (i.e., ionized) whereas other materials may be in a fluidized state in the heated carrier gas.

The carrier gas may be a non-reactive carrier gas or a reactive carrier gas, which is supplied at a flow rate suitable to support the movement of the reactants through the plasma-processing and to support the formation of the desired solid-state electrolyte materials. The non-reactive carrier gas may be considered as a carrier gas that does not itself engage in chemical interactions with the reactants during processing. For example, inert gasses such as argon and helium may be used as non-reactive carrier gasses. In preferred embodiments, the inert gas may be argon. A reactive carrier gas may be considered as a carrier gas that does chemically interact with the reactants during the plasma-processing. This may include direct chemical interactions involving the sharing of atomic species or catalytic activity imparted upon the precursors by the gas. In some embodiments, the reactive carrier gas may be one or more of a sulfur containing gas, for example, but not limited to hydrogen sulfide, sulfur vapor, sulfur hexafluoride. In another embodiment, the reactive carrier gas may be one or more of an oxygen containing gas, for example, but not limited to water, oxygen, and ozone. In another embodiment, the reactive carrier gas may be one or more of a nitrogen containing gas, for example, but not limited to ammonia, nitric oxide (NO₂, N₂O₄), and nitrogen gas. In another embodiment, the reactive carrier gas may be one or more of a halogen containing gas, for example, but not limited to chloride gas (Cl₂), bromine gas (Br₂), iodine gas (I₂), hydrogen fluoride, hydrogen chloride, or hydrogen bromide. In other embodiments, the reactive carrier gas may be a hydrocarbon, for example, but not limited to, methane. In another embodiment, the reactive carrier gas may a phosphorus-containing gas or a boron-containing gas. Carrier gasses may also function to form intermediate compounds during the processing of the precursors into the desired final products. Some gases, such as nitrogen, may be reactive or non-reactive depending on the precursor composition and the plasma-assisted processing conditions. In preferred embodiments, the reactive carrier gas may be one or more of ammonia, sulfur, hydrogen sulfide, nitrogen, and methane.

The carrier gas pressure, flow rate, and species may be varied to adjust precursor heating, reaction kinetics, volume fraction and/or resultant solid-state electrolyte materials particle size.

In some embodiments, the carrier gas may have a flow rate of at least about 0.1 liters per minute per gram of reactants being processed. In some aspects, the carrier gas may have a flow rate of at least about 0.1, at least 0.2, at least 0.3, at least 0.4, at least 0.5, at least 0.6, at least 0.7, at least 0.8, at least 0.9, at least 1.0, at least 2.0, at least 3.0, at least 4.0, at least 5.0, at least 6.0, at least 7.0, at least 8.0, at least 9.0, or at least 10.0 liters per minute per gram of reactants being plasma-processed.

In additional embodiments, the carrier gas may have a flow rate from about 0 to about 100 liters per minute. In some aspects, the carrier gas may have a flow rate from about 0 liters per minute to about 10 liters per minute, about 0 liters per minute to about 20 liters per minute, about 0 liters per minute to about 30 liters per minute, about 0 liters per minute to about 40 liters per minute, about 0 liters per minute to about 50 liters per minute, about 0 liters per minute to about 60 liters per minute, about 0 liters per minute to about 70 liters per minute, about 0 liters per minute to about 80 liters per minute, about 0 liters per minute to about 90 liters per minute, about 10 liters per minute to about 100 liters per minute, about 20 liters per minute to about 100 liters per minute, about 30 liters per minute to about 100 liters per minute, about 40 liters per minute to about 100 liters per minute, about 50 liters per minute to about 100 liters per minute, about 60 liters per minute to about 100 liters per minute, about 70 liters per minute to about 100 liters per minute, about 80 liters per minute to about 100 liters per minute, about 90 liters per minute to about 100 liters per minute, about 10 liters per minute liters per minute to about 20 liters per minute, about 20 liters per minute to about 30 liters per minute, about 30 liters per minute to about 40 liters per minute, about 40 liters per minute to about 50 liters per minute, about 50 liters per minute to about 60 liters per minute, about 60 liters per minute to about 70 liters per minute, about 70 liters per minute to about 80 liters per minute, about 80 liters per minute to about 90 liters per minute, or about 90 liters per minute to about 100 liters per minute. In some aspects, the carrier gas may have a flow rate of greater than 0 liters per minute. In some additional aspects, the carrier gas may have a flow rate of greater than 100 liters per minute.

In some embodiments, the carrier gas pressure may be from about 1×10⁻⁹ Torr to 7600 Torr. In some aspects, the carrier gas pressure may range from about 1×10⁻⁹ Torr to about 1×10⁻⁸ Torr, about 1×10⁻⁹ Torr to about 1×10⁻⁷ Torr, about 1×10⁻⁹ Torr to about 1×10⁻⁶ Torr, about 1×10⁻⁹ Torr to about 1×10⁻⁵ Torr, about 1×10⁻⁹ Torr to about 1×10⁻⁴ Torr, about 1×10⁻⁹ Torr to about 1×10⁻³ Torr, about 1×10⁻⁹ Torr to about 1×10⁻² Torr, about 1×10⁻⁹ Torr to about 1×10⁻¹ Torr, about 1×10⁻⁹ Torr to about 1 Torr, about 1×10⁻⁹ Torr to about 10 1×10⁻⁹ Torr, about 1×10⁻⁹ Torr to about 100 Torr, about 1×10⁻⁹ Torr to about 500 Torr, about 1×10⁻⁹ Torr to about 1000 Torr, about 1×10⁻⁹ Torr to about 5000 Torr, about 1×10⁻⁸ Torr to about 7600 Torr, about 1×10⁻⁷ Torr to about 7600 Torr, about 1×10⁻⁶ Torr to about 7600 Torr, about 1×10⁻⁵ Torr to about 7600 Torr, about 1×10⁻⁴ Torr to about 7600 Torr, about 1×10⁻³ Torr to about 7600 Torr, about 1×10⁻² Torr to about 7600 Torr, about 1×10⁻¹ Torr to about 7600 Torr, 1 Torr to about 7600 Torr, about 10 Torr to about 7600 Torr, about 100 Torr to about 7600 Torr, about 500 Torr to about 7600 Torr, about 1000 Torr to about 7600 Torr, about 5000 Torr to about 7600 Torr, about 1 Torr to about 1000 Torr, about 10 Torr to about 1000 Torr, about 100 Torr to about 1000 Torr, about 500 Torr to about 1000 Torr, about 1 Torr to about 500 Torr, about 10 Torr to about 500 Torr, or about 100 Torr to about 500 Torr.

Varying the parameters of the carrier and reactive gases changes the fluidization of the reactants and the resultant density of reactants undergoing plasma processing. This, in-turn, alters the thermal dynamics and the processing time and temperature requirements. Proper selection of the reaction temperature and duration of reaction avoids the creation of undesired products and provides for a very fast synthesis. Additionally, many reactants materials and reaction products, especially sulfide materials, may react strongly with metals, such as stainless steel, aluminum, nickel, iron, chrome, etc. that can result in contamination of the products. Processing in a fluidized and/or gaseous state avoids this issue.

Excitation of the plasma may be adjusted to achieve an effective heating temperature from about 70° C. to about 1200° C. In some embodiments, the effective heating temperature may range from about 70° C. to about 100° C., about 70° C. to about 150° C., about 70° C. to about 200° C., about 70° C. to about 250° C., about 70° C. to about 300° C., about 70° C. to about 350° C., about 70° C. to about 400° C., about 70° C. to about 450° C., about 70° C. to about 500° C., about 70° C. to about 550° C., about 70° C. to about 600° C., about 70° C. to about 650° C., about 70° C. to about 600° C., about 70° C. to about 650° C., about 70° C. to about 700° C., about 70° C. to about 750° C., about 70° C. to about 800° C., about 70° C. to about 850° C., about 70° C. to about 900° C., about 70° C. to about 950° C., about 70° C. to about 1000° C., about 70° C. to about 1100° C., about 100° C. to about 1200° C., about 150° C. to about 1200° C., about 200° C. to about 1200° C., about 250° C. to about 1200° C., about 300° C. to about 1200° C., about 350° C. to about 1200° C., about 400° C. to about 1200° C., about 450° C. to about 1200° C., about 500° C. to about 1200° C., about 550° C. to about 1200° C., about 600° C. to about 1200° C., about 650° C. to about 1200° C., about 700° C. to about 1200° C., about 750° C. to about 1200° C., about 800° C. to about 1200° C., about 850° C. to about 1200° C., about 900° C. to about 1200° C., about 950° C. to about 1200° C., about 1000° C. to about 1200° C., about 1100° C. to about 1200° C., about 100° C. to about 1100° C., about 200° C. to about 1000° C., about 300° C. to about 900° C., about 400° C. to about 800° C., or about 500° C. to about 700° C. In some embodiments, the effective heating temperature may be greater than about 70° C. In some embodiments, the effective heating temperature may be greater than about 1200° C. In some embodiments, excitation of the plasma may be adjusted to achieve an effective heating temperature from about 70° C. to about 1500° C., about 1000° C. to about 2000° C., about 70° C. to about 2000° C., about 2000° C. to about 3000° C., about 70° C. to about 3000° C., about 3000° C. to about 4000° C., about 70° C. to about 4000° C., about 4000° C. to about 5000° C., or about 70° C. to about 5000° C. In some embodiments, the effective heating temperature may be greater than about 5000° C. It will be appreciated by those having ordinary skill in the art that different materials may be heated to different effective heating temperatures during the plasma processing based on factors including the heat capacity of the material, thermal conductivity of the material, flow rate of the material through the plasma, particle size of the material, etc.

The heating may specifically reach a crystallization temperature of a desired precursor and maintain that temperature for a fast reaction period of, for example, greater than about 1 microsecond to about 60 seconds to support formation of the desired precursor. In some aspects, the crystallization temperature may be maintained for a period from about 1 microsecond to about 10 microseconds, about 1 microsecond to about 100 microseconds, about 1 microsecond to about 1 millisecond, about 1 microsecond to about 10 milliseconds, about 1 microsecond to about 100 milliseconds, about 1 microsecond to about 1 second, about 1 microsecond to about 10 seconds, about 1 microsecond to about 30 seconds, about 10 microseconds to about 60 seconds, about 100 microseconds to about 60 seconds, about 1 millisecond to about 60 seconds, about 10 milliseconds to about 60 seconds, about 100 milliseconds to about 60 seconds, about 1 second to about 60 seconds, about 10 seconds to about 60 seconds, about 30 seconds to about 60 seconds. In some aspects, the crystallization temperature may be maintained for a period from about 10 microseconds to about 1 seconds, about 100 microseconds to about 1 second, about 1 millisecond to about 1 second, about 10 milliseconds to about 1 second, about 100 milliseconds to about 1 second, about 10 microseconds to about 100 milliseconds, about 10 microseconds to about 10 milliseconds, about 10 microseconds to about 1 millisecond, or about 10 microseconds to about 100 microseconds.

In some embodiments, the resultant precursors may have a particle size from about 1 nm to about 10 mm. In some aspects, the resultant precursors may have a particle size from about 1 nm to about 50 nm, about 1 nm to about 100 nm, about 1 nm to about 250 nm, about 1 nm to about 500 nm, about 1 nm to about 750 nm, about 1 nm to about 1 μm about 1 nm to about 10 μm, about 1 nm to about 50 μm, about 1 nm to about 100 μm, about 1 nm to about 250 μm, about 1 nm to about 500 μm, about 1 nm to about 750 μm, about 1 nm to about 1 mm, about 1 nm to about 5 mm, or about 1 nm to about 10 mm.

Resultant precursors may be further processed in step 350 and, for example, further plasma processed into solid-state electrolyte materials. In some embodiments, step 350 may include reducing the particle size of the solid-state electrolyte materials such as by milling, grinding, high shear mixing, thermal treating and other methods. In some embodiments, step 350 may include washing the solid-state electrolyte materials. In still further embodiments, step 350 may include coating the solid-state electrolyte materials.

In some embodiments, the resultant precursors may have a purity of about 30% by weight or greater. In some aspects, the resultant precursors may have a purity of about 30% to about 40%, about 30% to about 50%, about 30% to about 60%, about 30% to about 70%, about 30% to about 80%, about 30% to about 90%, about 30% to about 95%, about 30% to about 99%, about 30% to about 99.9%, about 40% to about 99.9%, about 50% to about 99.9%, about 60% to about 99.9%, about 70% to about 99.9%, about 80% to about 99.9%, about 90% to about 99.9%, about 40% to about 50%, about 50% to about 60%, about 60% to about 70%, about 70% to about 80%, about 80% to about 90%, about 90% to about 95%, or about 95% to about 99.9% by weight. In some exemplary embodiments, the precursors may have a purity of greater than about 80% by weight, greater than about 90% by weight, greater than about 95% by weight, greater than about 97% by weight, greater than about 98% by weight, greater than about 99% by weight, or greater than about 99.9% by weight.

In some embodiments, the precursors made by the process 300 may include Li₂S, P₃N₅, B₂S₃, Li₃N, SiS₂, GeS, or LiX₍₁₋ₐ₎Yₐ, where X and Y include halogens, such as F, Cl, Br, or I, and pseudohalogens, such as BH₄, BF₄, OCN, CN, SCN, SH, NO, or NO₂ where 0≤a≤1.

In some embodiments, the reactants may produce the desired precursor as well as a byproduct. The byproducts from these reactions may include, but are not limited to, CO, CO₂, H₂O, H₂S, O₂, N₂, NOₓ, S, SO, SO₂, and CS₂. Those having ordinary skill in the art will appreciate that the byproducts produced will depend on the reactants included in the synthesis. In some aspects, the process 300 may include separating the byproducts from the precursor. The separating may be accomplished by separation methods known to those having skill in the art. In some aspects, the separating may be accomplished by venting gaseous byproducts to a ventilation hood or to a scrubber.

In some embodiments, the reaction for producing the desired precursor may include, but is not limited to the following:

Li₂CO₃+S→Li₂S+CO₂+0.5O₂

Li₂CO₃+S(excess)→Li₂S+CO₂+0.5O₂

Li₂SO₄+4C→Li₂S+4CO

2LiOH+H₂S→2Li₂S+2H₂O

3P₂S₅+10NH₃→P₃N₅+15H₂S

2B+3S→B₂S₃

3LiOH+NH₃→Li₃N+3H₂O

LiX+LiY→LiX₍₁₋ₐ₎Yₐ

where X and Y include halogens, such as F, Cl, Br, or I, and pseudohalogens, such as BH₄, BF₄, OCN, CN, SCN, SH, NO, or NO₂ where 0≤a≤1. The plasma in the previous examples can be reactive or non-reactive. Any of the chemical reactions described herein may be produced in a solvent free manner.

When a reactive carrier gas or plasma is used, the reactions may resemble the following where (RCG/P=Reactive Carrier Gas or Plasma):

2LiOH+H₂S(RCG/P)→Li₂S+2H₂O+Li₂S+P₂S₅+LiX

Li₂CO₃+H₂S(RCG/P)→Li₂S+H₂O+CO₂+Li₂S+P₂S₅+LiX

In these exemplary reactions, the plasma may heat the materials to the reaction temperature, and/or the reactive carrier gas H₂S may be ionized to form a plasma, which then reacts with the reactant(s).

The H₂O and/or CO₂ can be removed before introducing the remaining materials allowing for a water- and oxide-free solid electrolyte material. As used herein, a “water-free solid electrolyte material” refers to a material that includes less than 10 wt % water, including less than 9 wt % water, less than 8 wt % water, less than 7 wt % water, less than 6 wt % water, less than 5 wt % water, less than 4 wt % water, less than 3 wt % water, less than 2 wt % water, less than 1 wt % water, less than 0.5 wt % water, less than 0.1 wt % water, less than 0.01 wt % water, and less than 0.001 wt % water. As used herein, an “oxide-free solid electrolyte material” refers to a material that includes less than 10 wt % oxide, including less than 9 wt % oxide, less than 8 wt % oxide, less than 7 wt % oxide, less than 6 wt % oxide, less than 5 wt % oxide, less than 4 wt % oxide, less than 3 wt % oxide, less than 2 wt % oxide, less than 1 wt % oxide, less than 0.5 wt % oxide, less than 0.1 wt % oxide, less than 0.01 wt % oxide, and less than 0.001 wt % oxide.

When the carrier gas is NH₃, the reaction may be:

3P₂S₅+10NH₃(RCG/P)→2P₃N₅+15H₂S

3LiOH+NH₃(RCG/P)→Li₃N+3H₂O

The H₂S and the H₂O can be removed from the above reactions, leaving the final resultant materials to react according to:

P₂S₅+NH₃(RCG/P)→P₃N₅+H₂S→P₃N₅+LiOH+NH₃(RCG/P)→P₃N₅+Li₃N+H₂O→P₃N₅+Li₃N

In some examples, a new carrier gas may be generated during the plasma-processing. A non-limiting example of generating a new carrier gas during the plasma process is:

3P₂S₅+10NH₃(RCG/P)→2P₃N₅+15H₂S

The NH₃ is consumed in the reaction generating a new carrier gas, H₂S. The newly generated H₂S may be used to convert LiOH into Li₂S using the mechanism below:

2LiOH+H₂S→Li₂S+2H₂O

The newly generated H₂O may be removed from the system and the products from the two reactions may be passed though plasma to react according to:

3P₂S₅+10NH₃(RCG/P)→2P₃N₅+15H₂S+LiOH→P₃N₅+H₂S+Li₂S+H₂O→Li₂S+P₃N₅

In some embodiments, the resultant precursors may have the XRD pattern shown in FIG. 13. In some embodiments, the resultant precursors may have the XRD pattern shown in FIG. 14.

Process 300 terminates with step 360.

It will be appreciated that the plasma processing may be completed in stages. In some embodiments, for example, the process 300 may be performed to provide precursors 120 in process 100; similarly, processing resultant material 350 in process 300 may include process 100, i.e., synthesizing solid-state electrolyte materials. In a non-limiting example, a reactive carrier gas in a first plasma may convert typically lower-cost lithium compounds, such as LiOH, Li₂CO₃, and Li₂SO₄ into precursors (e.g., Li₂S or LiCl) suitable for the formation of desired solid-state electrolyte materials. In another non-limiting example, the plasma processing of LiOH using a reactive carrier gas, such as H₂S, results in the precursor Li₂S and the byproduct H₂O. In another non-limiting example, the plasma processing of Li₂CO₃ using a reactive carrier gas, such as HCl, HBr, or HI, results in the precursor LiCl, LiBr, or LiI, and the byproducts H₂O and COx. The water or other byproducts may be removed by gas/solid separation, such as vacuum processing, leaving the precursor Li₂S available for further electrolyte synthesis. The resultant Li₂S may then be mixed with other precursors (e.g., P₂S₅ and LiCl). This mixture may then be passed through a second plasma to synthesize the solid-state electrolyte material. In another non-limiting example, Li₂S and P₂S₅ may be first reacted in a first plasma to form a glassy or crystalline electrolyte material. This material may then be mixed with LiCl or other precursor materials, then be passed through a second plasma to synthesize the final solid-state electrolyte material. It will be appreciated by those having skill in the art that each stage may have different parameters compared to the stage preceding it or following it, including the species of carrier gas, temperature, pressure, flow rate, size of reactor, particle size of the reactants or precursors, etc.

The plasma processing 340 of process 300 or the plasma processing 140 of process 100 may be accomplished via a powder thermal spray process or via a pellet process, described in more detail below.

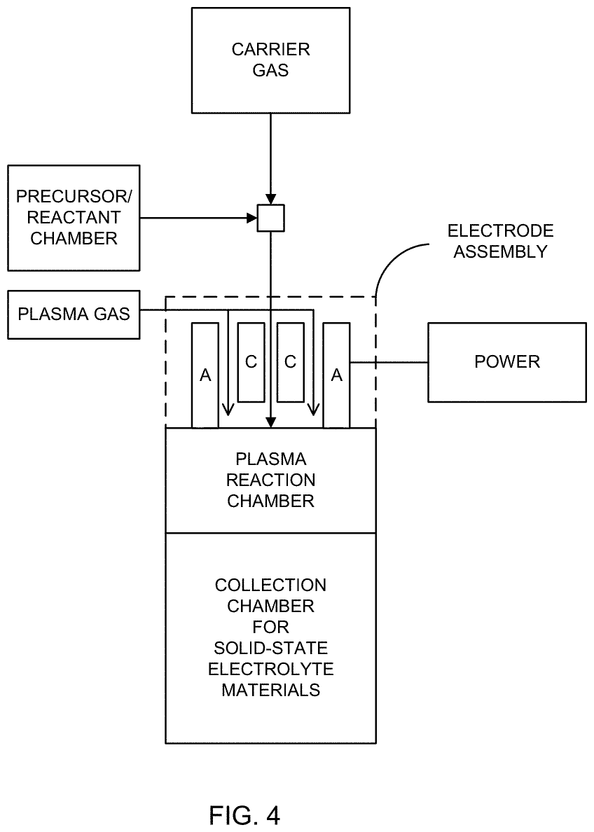

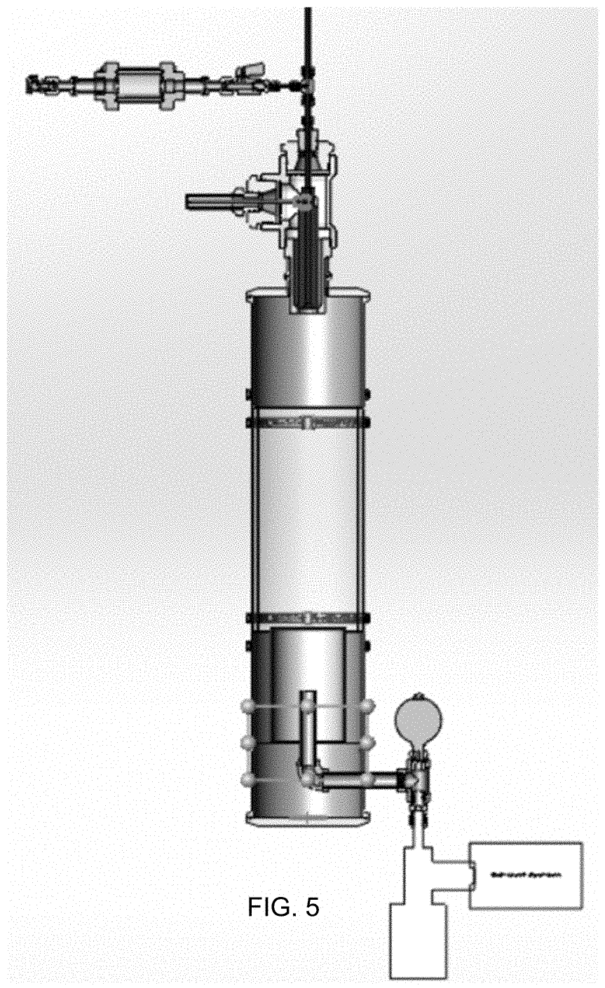

Provided herein is a method of synthesizing a solid-state electrolyte material or a solid-state electrolyte precursor via a powder thermal spray process. FIG. 4 shows a flow chart of a powder thermal spray plasma processing apparatus of the present disclosure. The plasma processing apparatus includes a carrier gas feed, a reactant or precursor powder feed, a plasma gas feed, a plasma torch, a power source, a cathode (C), an anode (A), a plasma reaction chamber, and a collection chamber for solid-state electrolyte materials. The carrier gas carries the reactant or precursor powder feed to the plasma reaction chamber. The power source provides the excitation source to the plasma gas to generate the plasma. An exemplary plasma-processing apparatus design is shown in FIG. 5.

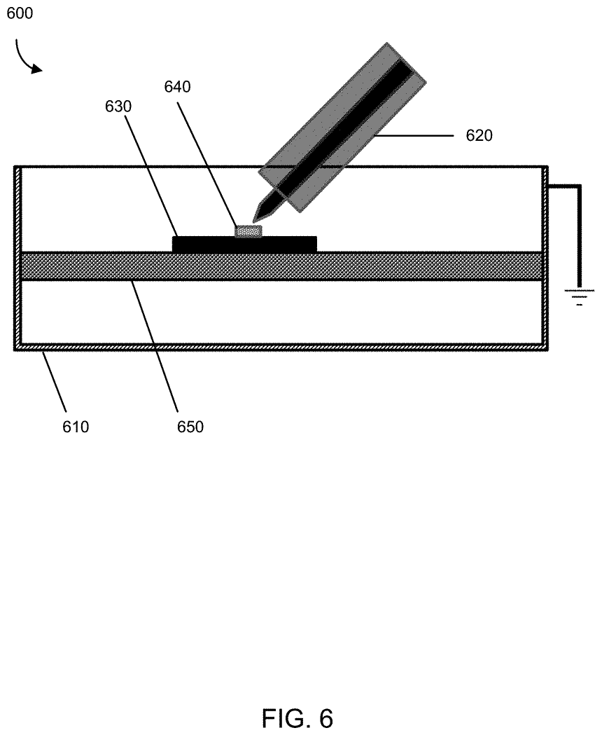

Further provided herein is a method of preparing a solid-state electrolyte material or a solid-state electrolyte precursor via a pellet process. FIG. 6 shows another exemplary plasma-processing apparatus design, useful for forming pellets of solid-state electrolyte material or solid-state electrolyte precursors. The apparatus 600 is placed in a glove box having an inert atmosphere. The reservoir 610 contains a cryogenic fluid that boils off to produce the inert atmosphere. The shrouded electrode 620 provides a gas to maintain the inert environment and a plasma gas. The shrouded electrode 620 may alternatively or additionally provide a carrier gas. The substrate 630 supports the pellet specimen 640 and completes the ground path through the porous conductive media 650 to the grounded reservoir 610. The shrouded electrode 620 and the substrate 630 may be any electrically conductive material. In preferred embodiments, the shrouded electrode and the substrate comprise graphite. In these embodiments, the precursors may be carried by the carrier gas and deposited as a pellet, or the precursors may already be in the form of a pellet and the plasma passes over the precursors.

In some embodiments, the cryogenic fluid in the reservoir 610 may be a liquid comprising nitrogen, argon, helium, hydrogen, neon, oxygen, methane, carbon monoxide, and other cryogenic liquids known in the art.

### EXAMPLES

### Example 1: Synthesis of LiRAP Material from LiCl and LiBr

The examples provided herein may describe novel compositions of matter produced by the processes described herein. For example, Li₃OCl₁₋ₓBrₓ was synthesized using the methods described herein. First, 4.92 g of LiCl (Sigma-Aldrich Co.) and 10.08 g of LiBr (Sigma-Aldrich Co.) were added to a 250 mL zirconia milling jar with zirconia milling media and a non-polar organic solvent. The mixture was then milled in a Retsch PM 100 planetary mill for 0.25 hours at 500 RPM. The material was collected and dried at 70° C. in an inert environment. The resulting mixture included 15 g of powder having a 1:1 Cl:Br molar ratio.

Ten grams of the powder was plasma processed by passing the material through a plasma torch head using argon as a carrier gas at a flow rate of about 10 liters per minute. A gas containing oxygen and nitrogen was used as a cooling gas and a reactive gas, and was introduced below the torch head at a flow rate of about 20 liters per minute. The powder was passed through the plasma over a 10 minute period, where the plasma had the shape of an expanded toroid. The calculated temperature of the plasma exceeded 4000° C. The powder spent approximately 100 ms in the hot zone.

The plasma-processed powder was characterized using X-Ray Diffraction (XRD), the results for which are shown in FIG. 7. The results show that the LiCl reacted with gaseous oxygen to produce a Li₃OCl₁₋ₓBrₓ solid electrolyte material. The XRD patterns confirms the formation of the Li₃OCl₁₋ₓBrₓ material, as broad diffraction peaks can be observed between the expected locations of the peaks of the pure end members Li₃OCl and Li₃OBr. Peaks representing Li₃OCl may be expected at 2θ=22.74°, 32.38°, 39.94°, 46.45°, 52.32°, and 57.76° with Cu—Kα(1,2)=1.54064 Å, while peaks representing Li₃OBr may be expected at 2θ=21.90°, 31.16°, 38.41°, 44.65°, 50.26°, and 55.45° with Cu—Kα(1,2)=1.54064 Å Those skilled in the art will conclude that the broad peaks observed between the expected peaks of Li₃OCl and Li₃OBr indicate that a solid solution of these two compounds is present, and may represent a range of composition described by Li₃OCl₁₋ₓBrₓ. FIG. 7 also shows unreacted LiCl, represented by peaks at 2θ=30.05°, 34.84°, and 50.10°, and unreacted LiBr represented by XRD peaks at 2θ=28.18°, 32.66°, 46.85°, and 55.58°. The XRD shows an Li₃OCl/Br phase with several overlapped peaks which indicates a small range of stoichiometry within Li₃OCl₁₋ₓBrₓ where x may be 0 to 1. The XRD also shows a phase of mixed halogens LiC₁₋ₓBrₓ where x may be 0 to 1. In the present example the lattice parameter of the mixed phase presents a value of 5.329 Å, which is close to value expected for a phase comprised of equal parts Cl and Br (5.310 Å). For this example, LiCl and LiBr were mixed in equal parts.

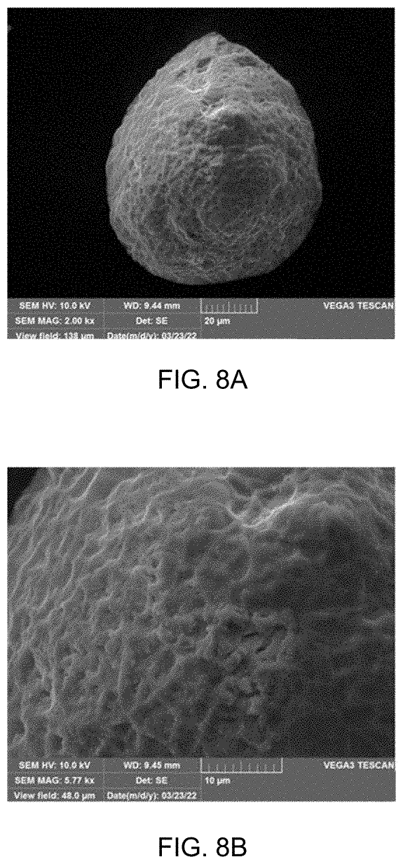

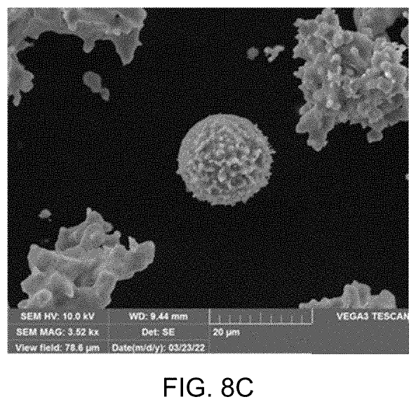

FIG. 8A shows a SEM image of a particle of Li₃OCl₁₋ₓBrₓ having a particle size of about 60-65 microns. The particle had a substantially spherical morphology that indicated the precursors melted together in the plasma. FIG. 8B is a zoomed-in view of the particle shown in FIG. 8A, and shows the texture of the surface of the plasma-processed material. FIG. 8C is another Li₃OCl₁₋ₓBrₓ particle, having a particle size of about 18 microns. The particle of FIG. 8C is also substantially spherical and has more pronounced surface texture as compared to the particle of FIGS. 8A and 8B.

FIG. 9A shows a SEM image of another particle that formed a glassy surface morphology. The selected area shown in FIG. 9A was characterized using energy-dispersive X-ray spectroscopy (EDS). The EDS spectra is shown in FIG. 9B, and the data are shown in Table 1 below.

TABLE 1

| | Weight | Atom | | Error | | | |
|---|---|---|---|---|---|---|---|
| Element | % | % | Net Int. | % | P/B Ratio | R | F |
| C K | 0.82 | 3.75 | 92.19 | 15.74 | 0.0000 | 1.0000 | 1.0000 |
| O K | 0.33 | 1.12 | 83.55 | 15.77 | 0.0000 | 1.0000 | 1.0000 |
| F K | 0.10 | 0.28 | 97.73 | 15.72 | 0.0000 | 1.0000 | 1.0000 |
| BrL | 67.27 | 46.16 | 2323.33 | 2.69 | 211.7900 | 1.0321 | 1.0027 |
| CIK | 31.48 | 48.69 | 1214.48 | 2.16 | 157.8212 | 1.0470 | 1.0058 |

The data shows the atomic percentage of Cl and Br to be much higher than oxygen. This suggests the formation of a LiCl—LiBr eutectic, where the two materials are melted together but did not react with oxygen. The resulting material likely has the formula LiClₓBr_{y}, where 0<x<1, 0<y<1, and x+y=1.

FIGS. 10A and 10B show another particle from the synthesis of Li₃OCl₁₋ₓBrₓ. The particle has a different particle morphology from the spherical particles, suggesting that the precursors did not completely melt together during the plasma-processing. The area marked “Selected Area 1” in FIG. 10B was characterized using EDS. The EDS spectra is shown in FIG. 10C, and the data is shown in Table 2 below.

TABLE 2

| | Weight | Atom | | Error | | | |
|---|---|---|---|---|---|---|---|
| Element | % | % | Net Int. | % | P/B Ratio | R | F |
| C K | 0.74 | 3.58 | 88.42 | 15.75 | 0.0000 | 1.0000 | 1.0000 |
| O K | 0.18 | 0.64 | 48.00 | 16.02 | 0.0000 | 1.0000 | 1.0000 |
| F K | 0.03 | 0.08 | 27.57 | 16.35 | 0.0000 | 1.0000 | 1.0000 |
| BrL | 73.33 | 53.44 | 2341.50 | 2.85 | 243.1441 | 1.0330 | 1.0024 |
| CIK | 25.73 | 42.26 | 916.18 | 2.20 | 135.8360 | 1.0483 | 1.0059 |

The data shows the atomic percentage of Cl and Br to be much higher than oxygen. This suggests the formation of a LiCl—LiBr eutectic, where the two materials are melted together but did not react with oxygen. The resulting material likely has the formula LiClₓBr_{y}, where 0<x<1, 0<y<1, and x+y=1.

FIG. 10D shows the atom composition of a broad area of the plasma-processed particle. The grey areas are unallocated species, the blue areas are areas including oxygen, and the red areas are areas including chlorine.

FIG. 10E shows another view of the atom composition of the particle. Purple pixels indicate carbon, green pixels indicate oxygen, orange pixels indicate fluorine, blue pixels indicate bromine, and pink pixels indicate chlorine. FIG. 10F shows the EDS spectrum of the area of the particle shown in FIG. 10A. The data for the EDS spectrum is shown in Table 3. FIG. 10G shows only the areas where bromine was detected. FIG. 10H shows only the areas where chlorine was detected.

TABLE 3

| | Weight | Atom | | Error | | | |
|---|---|---|---|---|---|---|---|
| Element | % | % | Net Int. | % | P/B Ratio | R | F |
| C K | 9.43 | 33.84 | 743.40 | 15.10 | 0.0000 | 1.0000 | 1.0000 |
| O K | 0.61 | 1.65 | 103.60 | 15.26 | 0.0000 | 1.0000 | 1.0000 |
| F K | 0.06 | 0.14 | 40.80 | 15.41 | 0.0000 | 1.0000 | 1.0000 |
| BrL | 66.39 | 35.80 | 1551.60 | 2.29 | 215.9075 | 1.0312 | 1.0024 |
| CIK | 23.51 | 28.58 | 703.70 | 1.64 | 121.7188 | 1.0457 | 1.0060 |

These data further confirm that the atomic percentage of chlorine and bromine were much higher than oxygen. This suggests that the LiCl—LiBr eutectic material described above was formed, as the two materials melted together and did not react with oxygen, but also did not form into a spherical particle. It is believed that a spherical particle was not formed due to a difference in the overall temperature exposure.

### Example 2: Synthesis of LiRAP Material from LiOH and LiCl

Li₃OCl was synthesized using the methods described in Example 1. First, 4.6951 g of LiCl and 5.3049 g of LiOH were added to a zirconia milling jar with 50 g of 5 mm zirconia milling media. The mixture was then milled for 5 minutes. The powder was collected and plasma-processed according to the process described in Example 1.

The XRD pattern for the resulting product is shown in FIG. 11. This experiment was intended to show the ability to create a lithium-rich antiperovskite phase (LiRAP) with general chemistry Li₃O(Halogen) from LiOH and LiCl. This reaction is known to work to give the desired product, and in this case the creation of the LiRAP phase from precursors passed through the plasma torch reactor was shown.

### Example 3: Synthesis of Li₁₀B₁₀S₂₀

First, 0.145 g of Boron (Sigma Aldrich Co.), 0.217 g of Li₂S (Lorad), and 0.638 g of sulfur powder (Sigma Aldrich Co.) were weighed. A pellet including the precursors was formed as described in Example 4, and plasma processing was performed as described in Example 4.

FIG. 12A (lower spectrum) shows the XRD pattern of the plasma-processed material.

### Example 4: Synthesis of Li₅B₇S₁₃

After the plasma-processing, 0.5 g of the material from Example 5 was sealed in a carbon-coated quartz tube and heated to 525° C. for 12 hours. FIG. 12A (upper spectrum) shows the XRD pattern of the annealed material.

Previously, Li₅B₇S₁₃ was synthesized by using an ampule melt process. In the ampule melt process, Li2S, boron, and sulfur were measured in a stoichiometric ratio and mortared together into a pellet. The pellets were pressed and loaded into a carbon coated quartz ampule and sealed under dynamic vacuum. The ampule was then heated in a rotating tube furnace at 1° C. per minute. The temperature was then held for 1 hour at 300° C., followed by 2 hours at 750° C., and then cooled to room temperature at a rate of 5° C. per minute. The resultant Li₅B₇S₁₃ was annealed as described above.

FIG. 12B shows a comparison of the XRD patterns for Li₁₀B₁₀S₂₀ and for Li₅B₇S₁₃ in the plasma treatment process and the ampule melt process.

### Example 5: Synthesis of Li₆PS₅Cl

First, 10.6877 g of Li₂S (Lorad), 10.3627 g of P₂S₅ (Sigma-Aldrich Co.), and 3.9485 g of LiCl (Sigma-Aldrich Co.) were added to a 250 mL zirconia milling jar with 400 g of 5 mm zirconia milling media and a non-polar organic solvent. The mixture was then milled in a Retsch PM 100 planetary mill for 12 hours at 500 RPM. The material was collected and dried at 70° C. in an inert environment for about 2 hours and then at 140° C. in an inert environment for about 2 hours.

The powder was plasma-processed in the same method as Example 1.

### Example 6: Synthesis of Li₆PS₅Cl in Nitrogen Plasma

First, 10.6877 g of Li₂S (Lorad), 10.3627 g of P₂S₅ (Sigma-Aldrich Co.), and 3.9485 g of LiCl (Sigma-Aldrich Co.) were added to a 250 mL zirconia milling jar with 400 g of 5 mm zirconia milling media and a non-polar organic solvent. The mixture was then milled in a Retsch PM 100 planetary mill for 12 hours at 500 RPM. The material was collected and dried at 70° C. in an inert environment for about 2 hours and then at 140° C. in an inert environment for about 2 hours.

Ten grams of the powder was plasma-processed by passing material through the plasma torch head using argon as a carrier gas at a flow rate of about 10 liters per minute. Additionally, a reactive nitrogen gas was introduced at the torch at a flow rate of about 20 liters per minute. The mixed precursor material was passed through a plasma at a rate of 1 gram per minute where the plasma had the shape of an extended toroid and a calculated temperature exceeding 4000° C. The precursor material spent about 100 ms in the hot zone.

FIG. 13 shows the XRD pattern from the plasma-processed material (upper) and of the precursor mixture prior to plasma-processing (lower). This experiment was intended to show the fast reaction of a milled mixture of Li2S+P2S5+LiCl in the plasma torch to create an ion conductor with an Argyrodite phase. As used here, “fast reaction” generally refers to a reaction that takes place in about 1 microsecond to about 60 seconds, including about 1 millisecond to about 1 second, including about 50 milliseconds to about 900 milliseconds, and further including about 100 milliseconds to about 800 milliseconds. The precursor mixture shows the composite containing Li₂S. LiCl, and P₂S₅. Specifically, the Li₂S is identified by the XRD peaks at 2θ=27.04°, 31.32°, and 44.88°, the LiCl is identified by the XRD peaks at 2θ=30.05°, 34.84°, and 50.10° with Cu—Kα(1,2)=1.54064 Å. Additionally, the P₂S₅ was reduced to an amorphous material and/or combined with Li₂S, identified by the broad XRD feature centered at 2θ=19°.

The XRD pattern from the plasma-processed material shows that Li₆PS₅Cl was successfully formed. The Li₆PS₅Cl is identified by the XRD peaks at 2θ=15.55°, 17.98°, 25.53°, 30.03°, and 31.40° with Cu—Kα(1,2)=1.54064 Å. The XRD pattern for the plasma-processed material also shows the presence of unreacted LiCl identified by XRD peaks at 2θ=30.05°, 34.84°, and 50.10°, and unreacted Li₂S identified by XRD peaks at 2θ=27.04°, 31.32°, and 44.88°. Other peaks present after the plasma treatment represent the impurities Li₂SO₄ and Li₃PO₄ which likely came from a small amount of air in the plasma reactor. The presence of Li₂S and LiCl after the plasma treatment indicated that the residence time of the powder in the plasma flume was too short to bring the reaction to completion. Additionally, small amounts of Li₃N and Li₇PN₄ were made by the plasma-processing.

### Example 7: Synthesis of Li₂S

First, 1 g of Li₂CO₃ (Sigma-Aldrich Co.) and 7 g of elemental sulfur powder (Sigma-Aldrich Co.) were added to a 50 mL zirconia milling jar with 40 g of zirconia milling media. The mixture was milled in a Spex mill for 5 hours. Next, the mixture was mortared together by hand for 10 minutes into a pellet. The pellet was plasma processed using an apparatus shown in FIG. 6.

FIG. 14 shows the XRD pattern for the plasma-processed material. The XRD pattern shows that Li₂S was synthesized, identified by XRD peaks at 2θ=27.04°, 31.32°, and 44.88°. The XRD shows that although the reaction did produce the desired Li₂S, the reaction was not complete.

### Example 8: Particle Size and Morphology of Li₆PS₅Cl Synthesized in a Reactive Environment

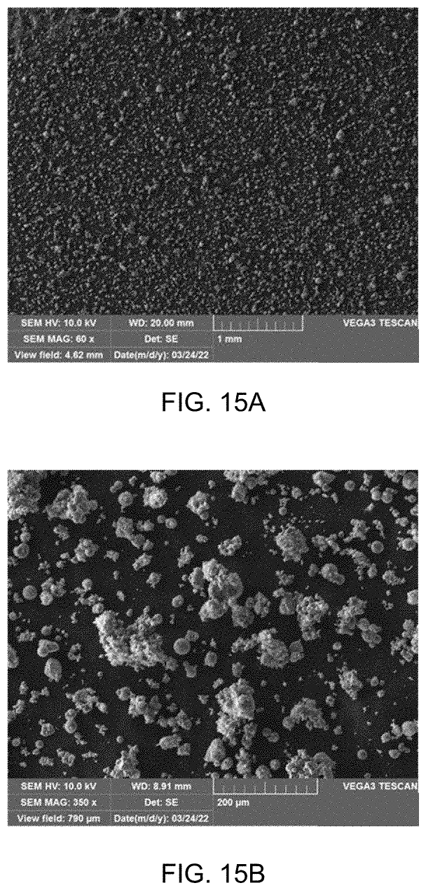

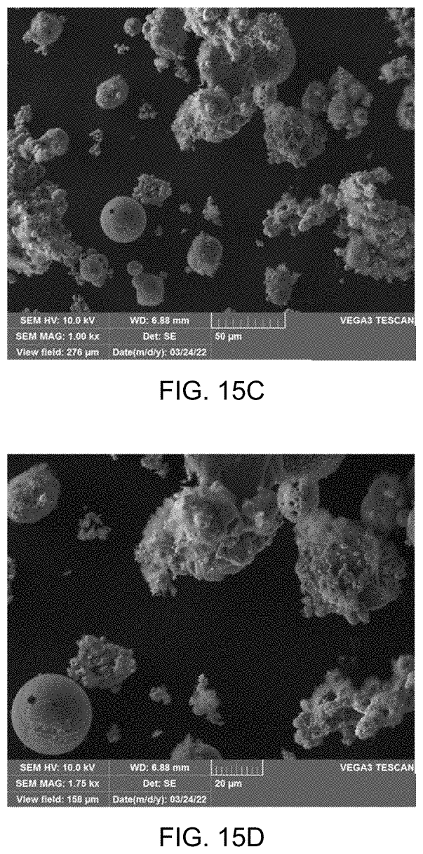

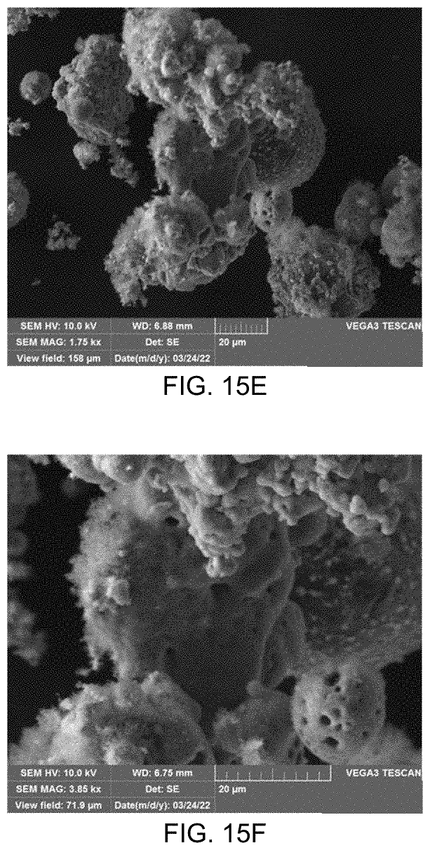

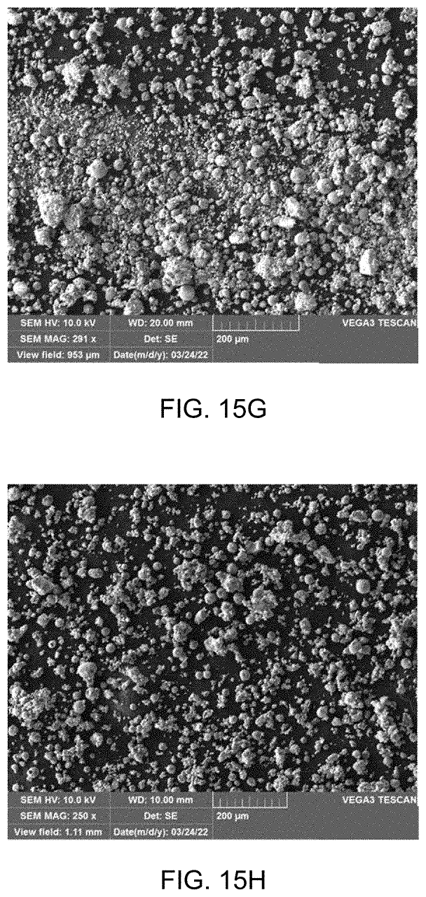

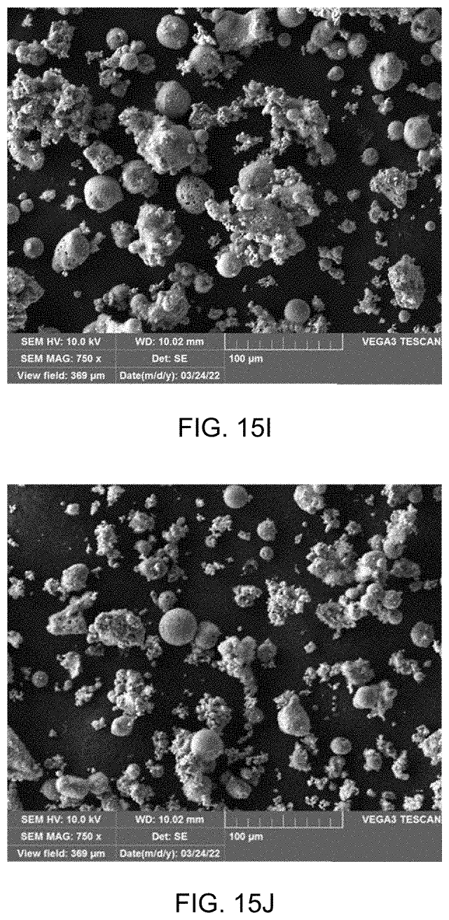

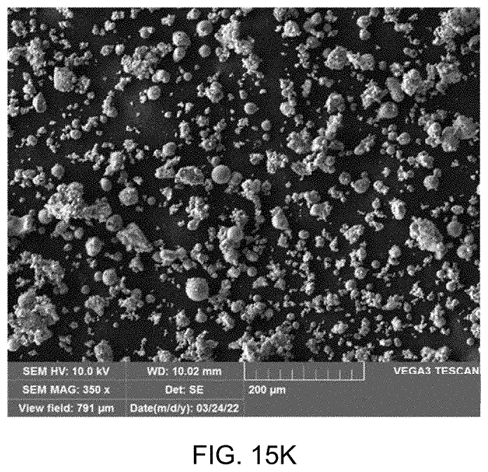

Li₆PS₅Cl was synthesized by the plasma-processing methods described herein using nitrogen as a reactive carrier gas. SEM images of the Li₆PS₅Cl are shown in FIGS. 13A-K. FIG. 15A shows a broad view of the particles and the range of particle sizes possible. FIGS. 13B-D are zoomed in images of FIG. 15A and shows particles in more detail. In particular, the bottom left corner of FIG. 15D shows a spherical particle of the Li₆PS₅Cl. The spherical morphology indicates that the precursors melted together and spent an ideal amount of time in the hot zone. In contrast, the jagged appearance of the particle shown in the center of FIG. 15E indicates that the particle did not spend enough time in the hot zone to allow the precursors to melt together. In further contrast, the particle shown in the bottom-right of FIG. 15F has several pits or holes. These features indicate volatilization and boiling of the particle as it traveled through the plasma, which is evidence that the particle spent too much time in the hot zone. FIGS. 15G-K show additional particles and their morphologies synthesized by the plasma-processing methods described herein.

### Example 9: Particle Size and Morphology of Li₆PS₅Cl Synthesized in an Inert Environment

Li₆PS₅Cl was synthesized by the plasma-processing methods described herein in an inert atmosphere. First, 10.6887 g of Li₂S (Lorad), 10.3627 g of P₂S₅ (Sigma-Aldrich Co.), and 3.9485 g of LiCl (Sigma-Aldrich Co.) were added to a 250 mL zirconia milling jar with 400 g of 5 mm zirconia milling media and a non-polar organic solvent. The mixture was then milled in a Retsch PM 100 planetary mill for about 12 hours at 500 RPM. The material was collected and dried in an inert environment at 70° C. for 2 hours, and then at 140° C. for 2 hours.

Ten grams of the material was plasma-processed by passing the powder through the plasma torch head using argon as a carrier gas at a flow rate of about 10 liters per minute. The mixed precursor material passed through the plasma at a rate of about 1 g per minute. The plasma had the shape of an extended toroid and a calculated temperature exceeding 4000° C. The precursor material spent about 100 ms in the hot zone.

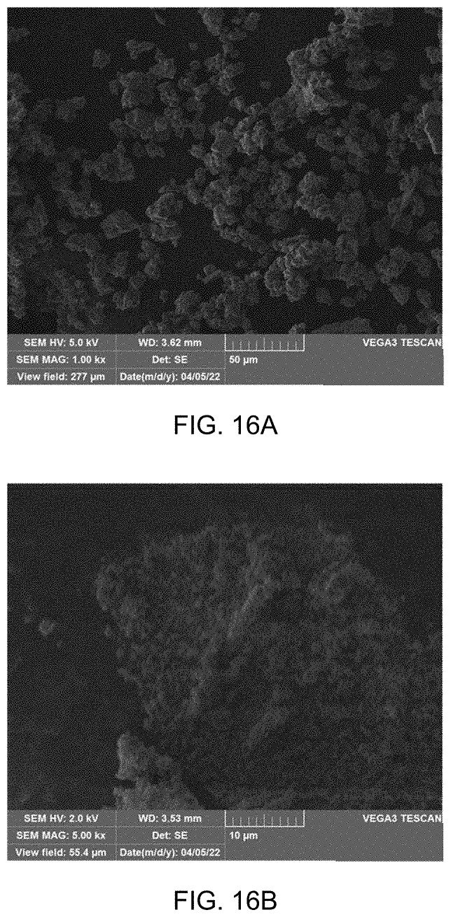

FIG. 16A shows an SEM image of the material after milling but before plasma-processing. The material had a particle size of greater than about 10 microns. FIG. 16B shows an SEM image of the plasma-processed material. The SEM image in particular shows a vapor condensation product that is below 100 nm in size. The composition of the starting material (FIG. 16A) was essentially the same as the synthesized material. This indicates that no unwanted materials such as oxides were introduced in the synthesis and no material was lost. FIG. 16B also shows that the plasma processed material included a glassy phase material and an amorphous material, which was additionally confirmed by XRD.

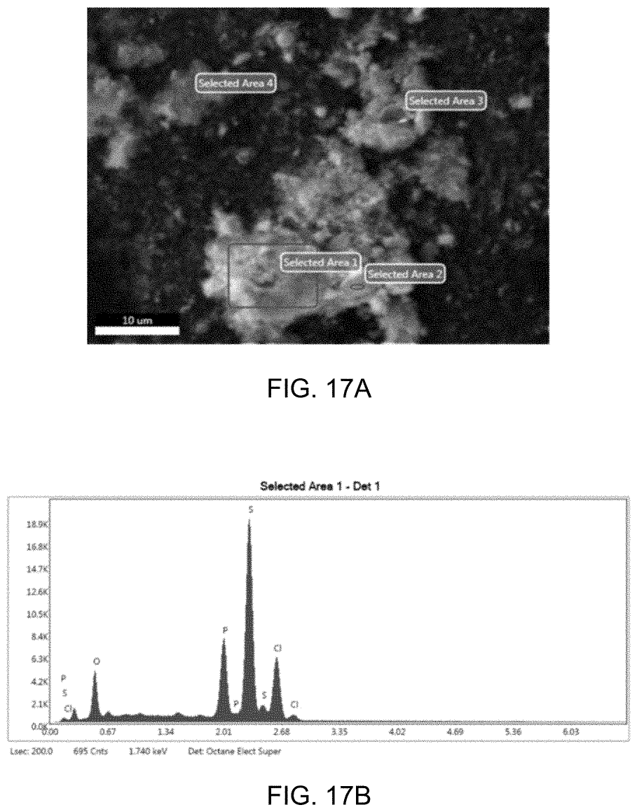

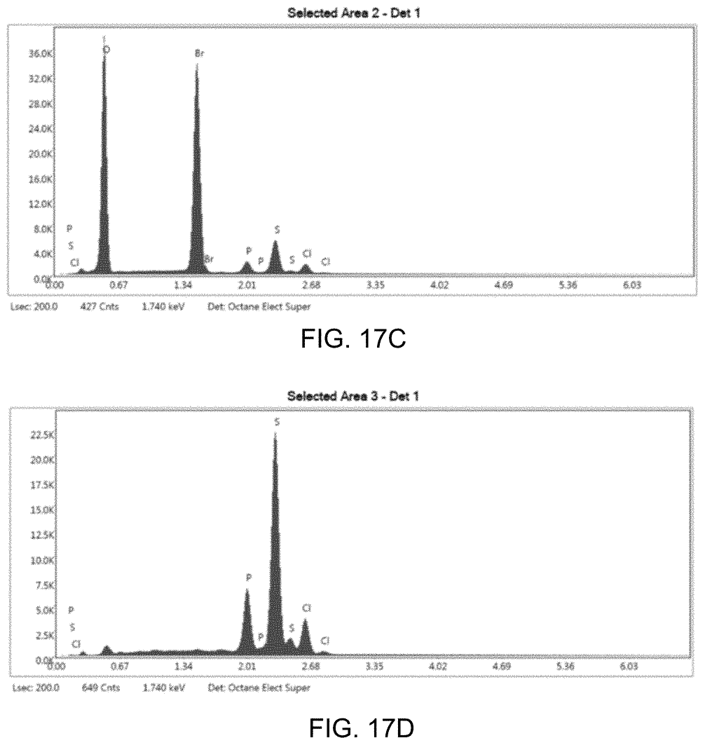

FIG. 17A shows an SEM image of the plasma-processed material with an overlay of various selected areas for EDS Analysis. FIGS. 17B-D show the EDS spectra for selected areas 1-3, the data for which are shown in Tables 4A-4C, respectively. Selected area 2 of FIG. 17A is an example of the plasma-processing performing a heat treatment and melting the precursors together, while selected area 1 is an example of the plasma-processing resulting in vaporization and condensation of the precursors. The heat treatment is generally evidenced by the formation of large and discrete particles (see FIG. 16A) whereas the vaporization and condensation is evidenced by submicron particles (see FIG. 16B) caused by the starting materials evaporating, reacting, cooling, and then condensing into nano-sized droplets.

TABLE 4A

| | Weight | Atom | | Error | | | |
|---|---|---|---|---|---|---|---|
| Element | % | % | Net Int. | % | P/B Ratio | R | F |
| O K | 11.77 | 21.35 | 134.64 | 15.61 | 0.0000 | 1.0000 | 1.0000 |
| P K | 16.93 | 15.87 | 350.36 | 3.72 | 110.4663 | 1.0254 | 1.0444 |
| S K | 50.81 | 46.00 | 903.84 | 3.22 | 346.6035 | 1.0277 | 1.0111 |
| CIK | 20.50 | 16.78 | 288.35 | 3.34 | 139.0578 | 1.0298 | 1.0047 |

TABLE 4B

| | Weight | Atom | | Error | | | |
|---|---|---|---|---|---|---|---|
| Element | % | % | Net Int. | % | P/B Ratio | R | F |
| O K | 7.13 | 21.51 | 1190.28 | 15.20 | 0.0000 | 1.0000 | 1.0000 |
| BrL | 67.45 | 40.75 | 1018.14 | 3.72 | 286.6774 | 1.0315 | 1.0025 |
| P K | 3.98 | 6.20 | 68.76 | 5.92 | 26.3549 | 1.0394 | 1.0061 |
| S K | 16.26 | 24.48 | 257.11 | 3.34 | 113.6772 | 1.0429 | 1.0052 |
| CIK | 5.18 | 7.06 | 67.62 | 5.39 | 35.3965 | 1.0462 | 1.0061 |

TABLE 4C

| | Weight | Atom | | Error | | | |
|---|---|---|---|---|---|---|---|
| Element | % | % | Net Int. | % | P/B Ratio | R | F |
| P K | 16.67 | 17.38 | 301.74 | 4.05 | 108.7927 | 1.0264 | 1.0557 |
| S K | 69.29 | 69.82 | 1066.42 | 3.37 | 466.2929 | 1.0288 | 1.0075 |
| CIK | 14.04 | 12.79 | 169.30 | 3.76 | 94.7835 | 1.0310 | 1.0046 |

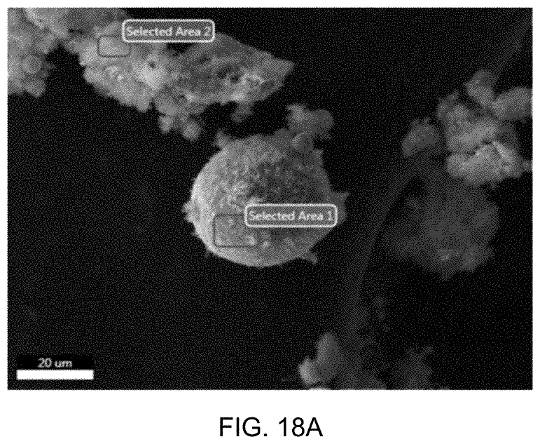

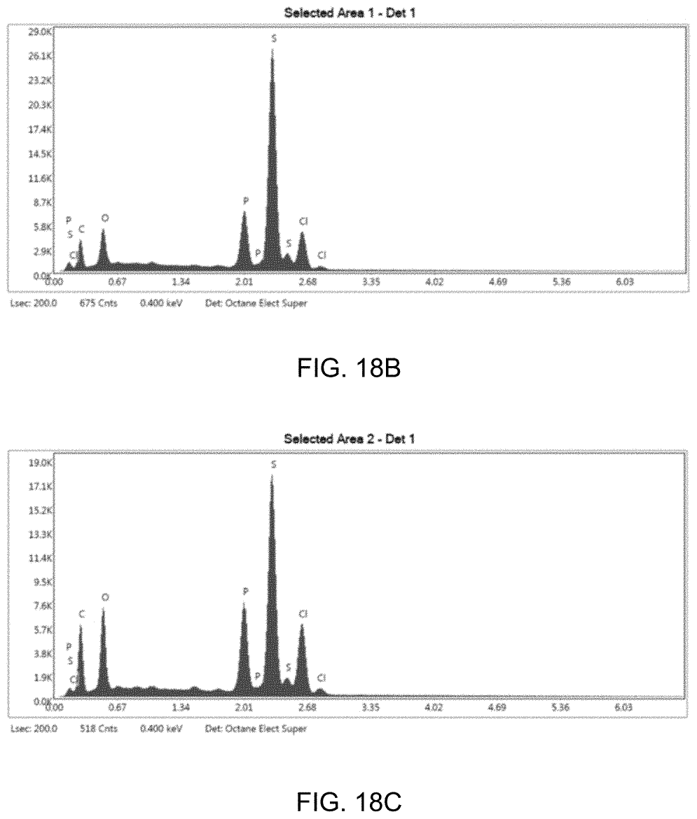

FIGS. 18A-C show another plasma-processed particle and the resulting EDS spectra. The particle with selected areas overlaid thereon is shown in FIG. 18A, and the EDS spectra for selected areas 1 and 2 are shown in FIGS. 18B and 18C, respectively. The data for the EDS spectra shown in FIGS. 18B and 18C are provided in Tables 5A and 5B, respectively.

TABLE 5A

| | Weight | Atom | | Error | | | |
|---|---|---|---|---|---|---|---|
| Element | % | % | Net Int. | % | P/B Ratio | R | F |
| C K | 11.99 | 24.94 | 86.28 | 15.76 | 0.0000 | 1.0000 | 1.0000 |
| O K | 9.02 | 14.09 | 138.31 | 15.60 | 0.0000 | 1.0000 | 1.0000 |
| P K | 11.86 | 9.57 | 312.33 | 3.75 | 87.2010 | 1.0242 | 1.0546 |
| S K | 54.89 | 42.77 | 1234.74 | 3.05 | 415.6673 | 1.0264 | 1.0082 |
| CIK | 12.24 | 8.62 | 217.25 | 3.50 | 92.6719 | 1.0284 | 1.0049 |

TABLE 5B

| | Weight | Atom | | Error | | | |
|---|---|---|---|---|---|---|---|
| Element | % | % | Net Int. | % | P/B Ratio | R | F |
| C K | 18.63 | 34.84 | 147.87 | 15.58 | 0.0000 | 1.0000 | 1.0000 |
| O K | 12.65 | 17.77 | 204.13 | 15.49 | 0.0000 | 1.0000 | 1.0000 |
| P K | 13.49 | 9.78 | 333.63 | 3.71 | 110.4664 | 1.0231 | 1.0417 |
| S K | 39.05 | 27.36 | 832.51 | 3.22 | 335.0338 | 1.0251 | 1.0115 |
| CIK | 16.18 | 10.25 | 274.87 | 3.51 | 137.6936 | 1.0270 | 1.0052 |

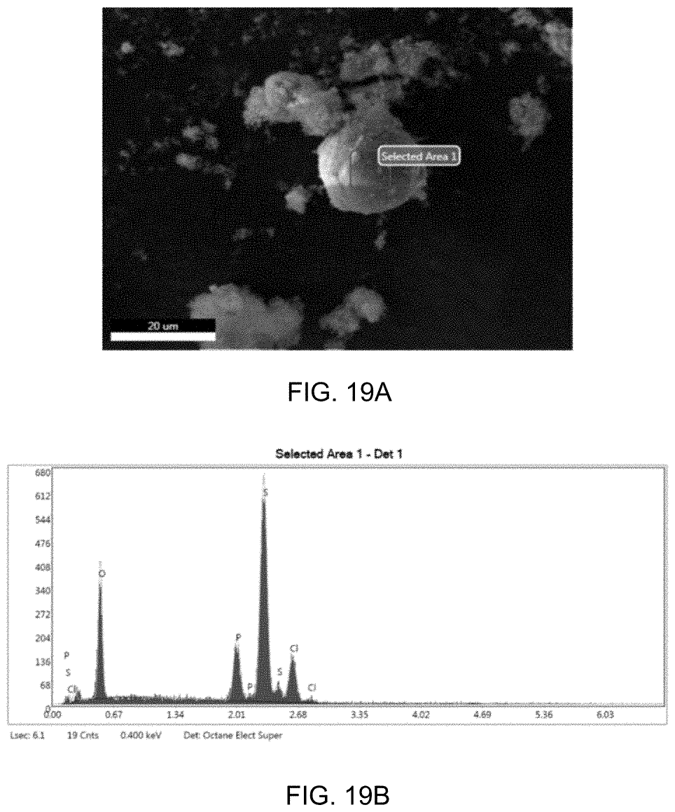

FIG. 19A shows another plasma-processed particle with a selected area overlaid thereon. The EDS spectra for the selected area is shown in FIG. 19B. The data for the EDS spectra shown in FIG. 19B is provided in Table 6.

TABLE 6

| | Weight | Atom | | Error | | | |
|---|---|---|---|---|---|---|---|
| Element | % | % | Net Int. | % | P/B Ratio | R | F |
| O K | 25.72 | 41.23 | 341.51 | 17.19 | 0.0000 | 1.0000 | 1.0000 |
| P K | 11.32 | 9.37 | 261.34 | 14.75 | 80.1813 | 1.0241 | 1.0499 |
| S K | 50.27 | 40.22 | 986.83 | 11.81 | 368.5017 | 1.0262 | 1.0087 |
| CIK | 12.69 | 9.18 | 195.59 | 18.46 | 92.8571 | 1.0282 | 1.0051 |

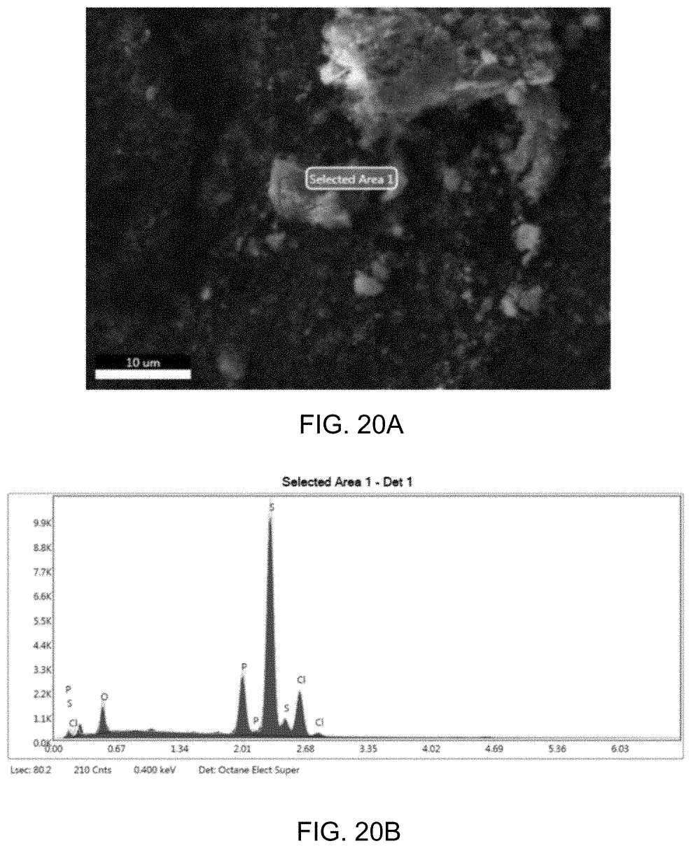

FIG. 20A shows another plasma-processed particle with a selected area overlaid thereon. The EDS spectra for the selected area is shown in FIG. 20B. The data for the EDS spectra shown in FIG. 20B is provided in Table 7.

TABLE 7

| | Weight | Atom | | Error | | | |
|---|---|---|---|---|---|---|---|
| Element | % | % | Net Int. | % | P/B Ratio | R | F |
| O K | 8.03 | 15.03 | 94.44 | 16.15 | 0.0000 | 1.0000 | 1.0000 |
| P K | 13.51 | 13.07 | 306.60 | 5.05 | 86.3219 | 1.0258 | 1.0563 |
| S K | 62.58 | 58.47 | 1200.11 | 4.18 | 411.7427 | 1.0280 | 1.0087 |
| CIK | 15.89 | 13.43 | 239.31 | 4.84 | 104.6379 | 1.0302 | 1.0047 |

Features described above, as well as those claimed below, may be combined in various ways without departing from the scope hereof. It should thus be noted that the matter contained in the above description or shown in the accompanying drawings should be interpreted as illustrative and not in a limiting sense. Accordingly, many combinations, permutations, variations and modifications of the foregoing embodiments of inventions not set forth explicitly herein will nevertheless fall within the scope of this disclosure.

What is claimed:

1. A method of synthesizing a solid-state electrolyte comprising:
(a) providing at least one precursor;
(b) preparing the at least one precursor for plasma-processing by milling, grinding, mixing, alloying, and/or high shear mixing; and
(c) plasma-processing the at least one precursor to form the solid-state electrolyte, wherein the plasma-processing includes at least providing a plasma gas and an excitation source to produce a plasma and providing a carrier gas to carry the at least one precursor through the plasma.

2. The method of claim 1, wherein the at least one precursor comprises one or more of at least one lithium-containing material, at least one phosphorus-containing material, at least one sulfur-containing material, and at least one halogen-containing material.

3. The method of claim 1, wherein the solid-state electrolyte comprises a crystalline material, a glass material, or a glass ceramic material.

4. The method of claim 2, wherein the lithium-containing material comprises Li₂S, Li₂O, Li₂CO₃, Li₂SO₄, LiNO₃, Li₃N, Li₂NH, LiNH₂, LiF, LiCl, LiBr, LiI, or LiX₍₁₋ₐ₎Yₐ, wherein the X and Y include halogens, such as F, Cl, Br, or I, and/or pseudohalogens, such as BH₄, BF₄, OCN, CN, SCN, SH, NO, or NO₂ where 0≤a≤1.

5. The method of claim 2, wherein the phosphorous-containing material comprises a phosphorous sulfide material, a phosphorus nitrogen material, or a phosphorus oxygen material.

6. The method of claim 2, wherein the phosphorous-containing material comprises a phosphorous sulfide material comprising a formula P₄Sₓ where 3≤x≤10.

7. The method of claim 2, wherein the phosphorous-containing material comprises elemental phosphorus, P₄S₄, P₄S₅, P₄S₆, P₄S₇, P₄S₈, P₄S₉, or P₄S₁₀ (P₂S₅), P₃N₅, or P₂O₅.

8. The method of claim 2, wherein the sulfur-containing material comprises an alkali sulfide, an alkaline earth sulfide, a transition metal sulfide, a post-transition metal sulfide, a metalloid sulfide, or elemental sulfur.

9. The method of claim 2, wherein the sulfur-containing material comprises H₂S, Li₂S, Na₂S, K₂S, BeS, MgS, CaS, SrS, BaS, TiS₂, ZrS₂, WS₂, FeS₂, NiS₂, CuS₂, AgS, ZnS, Al₂S₃, Ga₂S₃, SnS₂, Sn₂S₃, B₂S₃, SiS₂, GeS₂, Sb₂S₃, Sb₂S₅, or elemental sulfur.

10. The method of claim 2, wherein the halogen-containing material comprises a lithium halide, a sodium halide, a boron halide, an aluminum halide, a silicon halide, a phosphorus halide, a sulfur halide, a germanium halide, an arsenic halide, a selenium halide, a tin halide, an antimony halide, a tellurium halide, a lead halide, an yttrium halide, a magnesium halide, a bismuth halide, a zirconium halide, a lanthanum halide, a transition metal halide, or a lanthanide halide.

11. The method of claim 2, wherein the halogen-containing material comprises LiF, LiCl, LiBr, LiI, NaF, NaCl, NaBr, NaI, BCl₃, BBr₃, BI₃, AlF₃, AlBr₃, AlI₃, AlCl₃, SiF₄, SiCl₄, SiCl₃, Si₂Cl₅, SiBr₄, SiBrCl₃, SiBr₂Cl₂, SiI₄, PF₃, PF₅, PCl₃, PCl₅, POCl₃, PBr₃, POBr₃, PI₃, P₂Cl₄, P₂I₄, SF₂, SF₄, SF₆, S₂F₁₀, SCl₂, S₂Cl₂, S₂Br₂, GeF₄, GeCl₄, GeBr₄, GeI₄, GeF₂, GeCl₂, GeBr₂, GeI₂, AsF₃, AsCl₃, AsBr₃, AsI₃, AsF₅, SeF₄, SeFe₆, SeCl₂, SeCl₄, Se₂Br₂, SeBr₄, SnF₄, SnCl₄, SnBr₄, SnI₄, SnF₂, SnCl₂, SnBr₂, SnI₂, SbF₃, SbCl₃, SbBr₃, SbI₃, SbF₅, SbCl₅, TeF₄, Te₂F₁₀, TeF₆, TeCl₂, TeCl₄, TeBr₂, TeBr₄, TeI₄, PbF₄, PbCl₄, PbF₂, PbCl₂, PbBr₂, PbI₂, YF₃, YCl₃, YBr₃, YI₃, MgF₂, MgCl₂, MgBr₂, MgI₂, BiF₃, BiCl₃, BiBr₃, BiI₃, ZrF₄, ZrCl₄, ZrBr₄, ZrI₄, LaF₃, LaCl₃, LaBr₃, or LaI₃.

12. The method of claim 1, wherein the at least one precursor is selected from Li₂S, P₂S₅, and LiX, wherein X is one or more halide or pseudo-halide.

13. The method of claim 1, wherein the at least one precursor is reduced in size in step (b) to a particle size from about 1 nm to about 10 mm.

14. The method of claim 1, wherein the excitation source comprises an AC discharge, a DC discharge, a laser discharge, a radiofrequency source, or a microwave source.

15. The method of claim 1, wherein the carrier gas has a pressure from about 1×10⁻⁹ Torr to about 7600 Torr.

16. The method of claim 1, further comprising heating the at least one precursor to a crystallization temperature for a period from about 1 microsecond to about 60 seconds.

17. The method of claim 1, wherein the carrier gas comprises a reactive carrier gas or a non-reactive carrier gas.

18. The method of claim 1, wherein the carrier gas is one of H₂S and sulfur and the at least one precursor is one of Li₂CO₃, Li₂SO₄, and LiOH, which is converted to Li₂S by the plasma-processing.

19. The method of claim 1, wherein the carrier gas is one or more of HCl, HBr, and HI, and the at least one precursor is one of Li₂CO₃, Li₂SO₄, and LiOH, which is converted to one or more of a LiCl, LiBr, or LiI by the plasma-processing.

20. The method of claim 1, further comprising a second plasma-processing comprising a non-reactive carrier gas.

21. The method of claim 1, further comprising heating the at least one precursor to an effective heating temperature greater than about 70° C.

22. The method of claim 1, wherein the solid-state electrolyte has a substantially round shape.

23. The method of claim 22, wherein the solid-state electrolyte appears substantially similar to the solid-state electrolyte in FIG. 2B.

24. The method of claim 1, wherein step (b) is performed in a solvent-free environment.

25. The method of claim 1, wherein the solid-state electrolyte has an XRD pattern as shown in FIG. 7.

26. The method of claim 1, wherein the solid-state electrolyte has an XRD pattern as shown in FIG. 11.

27. The method of claim 1, wherein the solid-state electrolyte has an XRD pattern as shown in FIG. 12A.

28. The method of claim 1, wherein the solid-state electrolyte has an XRD pattern as shown in FIG. 12B.

29. The method of claim 1, wherein the solid-state electrolyte has an XRD pattern as shown in FIG. 13.

30. The method of claim 1, wherein the solid-state electrolyte has an XRD pattern as shown in FIG. 14.

31. The method of claim 1, wherein the solid-state electrolyte has an EDS spectrum as shown in FIG. 9B.

32. The method of claim 1, wherein the solid-state electrolyte has an EDS spectrum as shown in FIG. 10C.

33. The method of claim 1, wherein the solid-state electrolyte has an EDS spectrum as shown in FIG. 10F.

34. The method of claim 1, wherein the plasma-processing further comprises forming a eutectic material.

35. The method of claim 1, further comprising milling or grinding the solid-state electrolyte.

36. A solid-state electrolyte produced by the process of claim 1.

37. An electrochemical cell comprising the solid-state electrolyte of claim 36.

38. A method of synthesizing a solid-state electrolyte precursor comprising:
(a) providing at least one reactant;
(b) preparing the at least one reactant for plasma-processing by milling, grinding, mixing, alloying, and/or high shear mixing; and
(c) plasma-processing the at least one reactant to form the solid-state electrolyte precursor, wherein the plasma-processing comprises providing a plasma gas and an excitation source to produce a plasma and providing a carrier gas to carry the at least one reactant through the plasma.

39. The method of claim 38, wherein the at least one reactant is one or more of at least one lithium-containing reactant, at least one phosphorus-containing reactant, at least one sulfur-containing reactant.

40. The method of claim 39, wherein the at least one lithium-containing reactant comprises Li₂SO₄, LiOH, LiX, or LiY, where X and Y are halogens, such as F, Cl, Br, or I, and/or pseudohalogens, such as BH₄, BF₄, OCN, CN, SCN, SH, NO, or NO₂.

41. The method of claim 39, wherein the at least one phosphorus-containing reactant comprises P₂S₅ or elemental phosphorus.

42. The method of claim 39, wherein the at least one sulfur-containing reactant comprises H₂S or elemental sulfur.

43. The method of claim 38, wherein the at least one reactant comprises carbon, elemental boron, or ammonia.

44. The method of claim 38, wherein the at least one precursor is reduced in size in step (b) to a particle size from about 1 nm to about 10 mm.

45. The method of claim 38, wherein the excitation source comprises an AC discharge, a DC discharge, a laser discharge, a radiofrequency source, or a microwave source.

46. The method of claim 38, wherein the carrier gas has a pressure from about 1×10⁻⁹ Torr to about 7600 Torr.

47. The method of claim 38, wherein the carrier gas comprises a reactive carrier gas or a non-reactive carrier gas.

48. The method of claim 38, wherein step (b) is performed in a solvent-free environment.

49. The method of claim 38, wherein the solid-state electrolyte precursor has an XRD pattern as shown in FIG. 13.

50. The method of claim 38, wherein the solid-state electrolyte precursor has an XRD pattern as shown in FIG. 14.

51. The method of claim 38, further comprising milling or grinding the solid-state electrolyte precursor.

52. A method of synthesizing a solid-state electrolyte comprising:
(a) providing at least one reactant;
(b) preparing the at least one reactant for plasma-processing by milling, grinding, mixing, alloying, and/or high shear mixing;
(c) plasma-processing the at least one reactant to form at least one precursor, wherein the plasma-processing comprises providing a plasma gas and an excitation source to produce a plasma and providing a carrier gas to carry the at least one reactant through the plasma;
(d) preparing the at least one precursor for plasma-processing by milling, grinding, mixing, alloying, and/or high shear mixing; and
(e) plasma-processing the at least one precursor to form the solid-state electrolyte material, wherein the plasma-processing includes at least providing a plasma gas and an excitation source to produce a plasma and providing a carrier gas to carry the at least one precursor through the plasma.

53. A method of synthesizing Li₂S comprising:
(a) providing at least one reactant;
(b) preparing the at least one reactant for plasma-processing by milling, grinding, mixing, alloying, and/or high shear mixing; and
(c) plasma-processing the at least one reactant to form the Li₂S, wherein the plasma-processing includes at least providing a plasma gas and an excitation source to produce a plasma and providing a carrier gas to carry the at least one reactant through the plasma.

54. The method of claim 53, wherein the at least one reactant comprises Li₂CO₃ and elemental sulfur.

55. A method of synthesizing a solid-state electrolyte comprising:
(a) providing at least one precursor;
(b) preparing the at least one precursor for plasma-processing by milling, grinding, mixing, alloying, and/or high shear mixing;
(c) plasma-processing the at least one precursor to melting prior to forming the solid-state electrolyte, wherein the plasma-processing includes at least providing a plasma gas and an excitation source to produce a plasma and providing a carrier gas to carry the at least one precursor through the plasma; and
(d) quenching the solid-state electrolyte and/or the at least one precursor.

56. A method of synthesizing a solid-state electrolyte comprising:
(a) providing at least one precursor; and
(b) plasma-processing the at least one precursor to form the solid-state electrolyte, wherein the plasma-processing includes at least providing a plasma gas and an excitation source to produce a plasma and providing a carrier gas to carry the at least one precursor through the plasma.
